(19) United States
(12) Patent Application Publication
(10) Pub. No.: US 2017/0244294 A1
(43) Pub. Date: Aug. 24, 2017

(54) EQUIPMENT INCLUDING POLYTETRAFLUOROETHYLENE

(71) Applicant: SCHLUMBERGER TECHNOLOGY CORPORATION, Sugar Land, TX (US)

(72) Inventor: Jason Holzmueller, Lawrence, KS (US)

(21) Appl. No.: 15/506,185

(22) PCT Filed: Aug. 29, 2014
(86) PCT No.: PCT/US2014/053379

§ 371 Date: Feb. 23, 2017

(51) Int. Cl. H02K 3/30; E21B 47/06; E21B 43/12; H02K 5/132; H02K 3/34

(52) U.S. Cl. CPC H02K 3/30; H02K 5/132; H02K 3/345; E21B 43/128; E21B 47/065; E21B 43/2406

(57) ABSTRACT

An electric submersible pump motor can include a housing; a cavity defined at least in part by the housing; a rotor disposed in the cavity; a stator disposed in the cavity where the stator includes stator laminations and stator windings disposed at least in part in slots of the stator laminations; and stator slot liners disposed at least in part in the slots of the stator laminations where the stator slot liners include polytetrafluoroethylene and/or expanded polytetrafluoroethylene.

### BACKGROUND

Equipment used in the oil and gas industry may be exposed to high-temperature and/or high-pressure environments. Such environments may include fluids, gases, etc. that can damage equipment.

### SUMMARY

An electric submersible pump motor can include a housing; a cavity defined at least in part by the housing; a rotor disposed in the cavity; a stator disposed in the cavity where the stator includes stator laminations and stator windings disposed at least in part in slots of the stator laminations; and stator slot liners disposed at least in part in the slots of the stator laminations where the stator slot liners include polytetrafluoroethylene (PTFE) and/or expanded polytetrafluoroethylene (ePTFE).

An electric submersible pump motor can include a housing; a cavity defined at least in part by the housing; a rotor disposed in the cavity where the rotor includes rotor laminations and rotor windings disposed at least in part in slots of the rotor laminations; and a stator disposed in the cavity where the stator includes stator laminations and stator windings disposed at least in part in slots of the stator laminations, where the rotor windings, the stator windings or the rotor windings and the stator windings include expanded polytetrafluoroethylene (ePTFE).

An electric submersible pump motor can include a housing; a cavity defined at least in part by the housing; at least one component that includes polytetrafluoroethylene (PTFE) disposed in the cavity; and perfluoropolyether (PFPE) oil in the cavity and in contact with the polytetrafluoroethylene (PTFE). Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates examples of equipment in geologic environments;

FIG. 2 illustrates an example of an electric submersible pump system;

FIG. 3 illustrates examples of equipment;

FIG. 4 illustrates an example of a method for material and various applications for the material;

FIG. 5 illustrates an example of a power cable;

FIG. 6 illustrates an example of a motor lead extension;

FIG. 7 illustrates an example of a motor assembly;

FIG. 8 illustrates a diagram of a polymer, examples of micrographs and examples of layered materials;

FIG. 9 illustrates a diagram of a polymer, a diagram of an example of another polymer and a diagram of an example of a material;

FIG. 10 illustrates examples of methods; and

FIG. 11 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

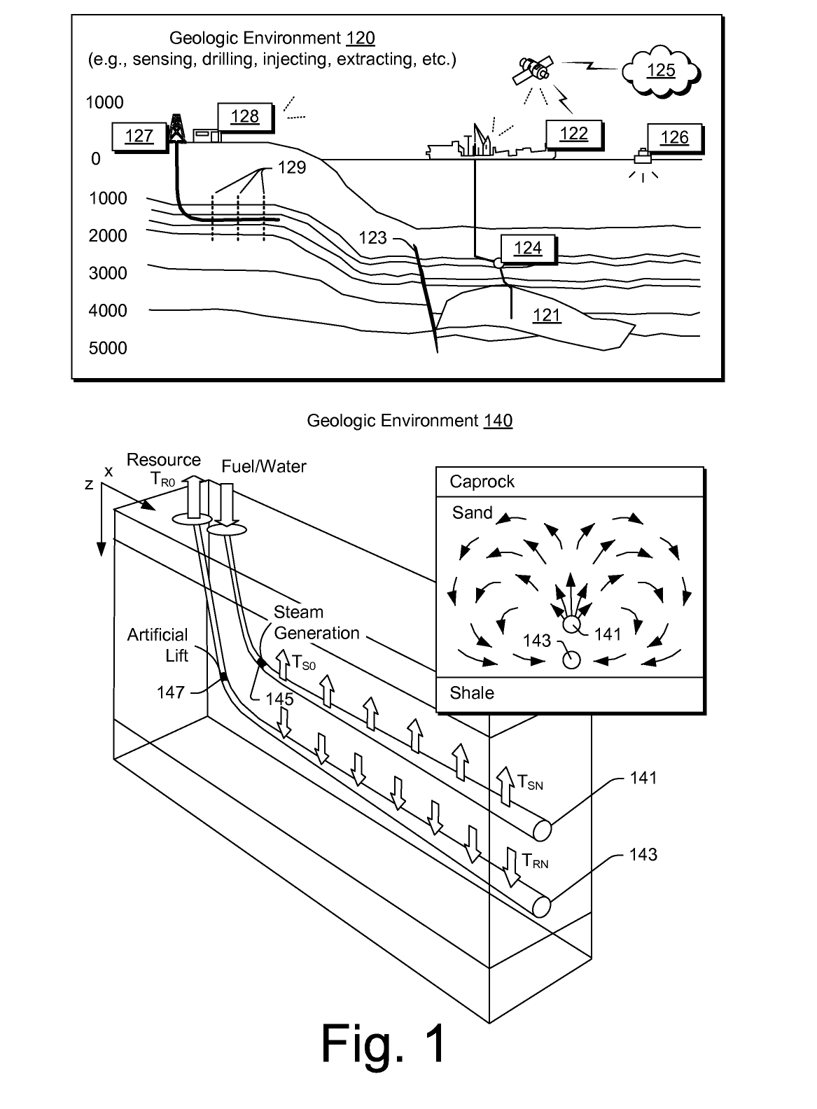

FIG. 1 shows examples of geologic environments 120 and 140. In FIG. 1, the geologic environment 120 may be a sedimentary basin that includes layers (e.g., stratification) that include a reservoir 121 and that may be, for example, intersected by a fault 123 (e.g., or faults). As an example, the geologic environment 120 may be outfitted with any of a variety of sensors, detectors, actuators, etc. For example, equipment 122 may include communication circuitry to receive and to transmit information with respect to one or more networks 125. Such information may include information associated with downhole equipment 124, which may be equipment to acquire information, to assist with resource recovery, etc. Other equipment 126 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 125 that may be configured for communications, noting that the satellite may additionally or alternatively include circuitry for imagery (e.g., spatial, spectral, temporal, radiometric, etc.).

FIG. 1 also shows the geologic environment 120 as optionally including equipment 127 and 128 associated with a well that includes a substantially horizontal portion that may intersect with one or more fractures 129. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop the reservoir (e.g., via fracturing, injecting, extracting, etc.). As an example, the equipment 127 and/or 128 may include components, a system, systems, etc. for fracturing, seismic sensing, analysis of seismic data, assessment of one or more fractures, etc.

As to the geologic environment 140, as shown in FIG. 1, it includes two wells 141 and 143 (e.g., bores), which may be, for example, disposed at least partially in a layer such as a sand layer disposed between caprock and shale. As an example, the geologic environment 140 may be outfitted with equipment 145, which may be, for example, steam assisted gravity drainage (SAGD) equipment for injecting steam for enhancing extraction of a resource from a reservoir. SAGD is a technique that involves subterranean delivery of steam to enhance flow of heavy oil, bitumen, etc. SAGD can be applied for Enhanced Oil Recovery (EOR), which is also known as tertiary recovery because it changes properties of oil in situ.

As an example, a SAGD operation in the geologic environment 140 may use the well 141 for steam-injection and the well 143 for resource production. In such an example, the equipment 145 may be a downhole steam generator and the equipment 147 may be an electric submersible pump (e.g., an ESP). As an example, one or more electrical cables may be connected to the equipment 145 and one or more electrical cables may be connected to the equipment 147. For example, as to the equipment 145, a cable may provide power to a heater to generate steam, to a pump to pump water (e.g., for steam generation), to a pump to pump fuel (e.g., to burn to generate steam), etc. As to the equipment 147, for example, a cable may provide power to power a motor, power a sensor (e.g., a gauge), etc.

As illustrated in a cross-sectional view of FIG. 1, steam injected via the well 141 may rise in a subterranean portion of the geologic environment and transfer heat to a desirable resource such as heavy oil. In turn, as the resource is heated, its viscosity decreases, allowing it to flow more readily to the well 143 (e.g., a resource production well). In such an example, equipment 147 may then assist with lifting the resource in the well 143 to, for example, a surface facility (e.g., via a wellhead, etc.).

As to a downhole steam generator, as an example, it may be fed by three separate streams of natural gas, air and water (e.g., via conduits) where a gas-air mixture is combined first to create a flame and then the water is injected downstream to create steam. In such an example, the water can also serve to cool a burner wall or walls (e.g., by flowing in a passageway or passageways within a wall). As an example, a SAGD operation may result in condensed steam accompanying a resource (e.g., heavy oil) to a well. In such an example, where a production well includes artificial lift equipment such as an ESP, operation of such equipment may be impacted by the presence of condensed steam (e.g., water). Further, as an example, condensed steam may place demands on separation processing where it is desirable to separate one or more components from a hydrocarbon and water mixture.

Each of the geologic environments 120 and 140 of FIG. 1 may include harsh environments therein. For example, a harsh environment may be classified as being a high-pressure and high-temperature environment. A so-called HPHT environment may include pressures up to about 138 MPa (e.g., about 20,000 psi) and temperatures up to about 205 degrees C. (e.g., about 400 degrees F.), a so-called ultra-HPHT environment may include pressures up to about 241 MPa (e.g., about 35,000 psi) and temperatures up to about 260 degrees C. (e.g., about 500 degrees F.) and a so-called HPHT-hc environment may include pressures greater than about 241 MPa (e.g., about 35,000 psi) and temperatures greater than about 260 degrees C. (e.g., about 500 degrees F.). As an example, an environment may be classified based in one of the aforementioned classes based on pressure or temperature alone. As an example, an environment may have its pressure and/or temperature elevated, for example, through use of equipment, techniques, etc. For example, a SAGD operation may elevate temperature of an environment (e.g., by 100 degrees C. or more).

As an example, an environment may be classified based at least in part on its chemical composition. For example, where an environment includes hydrogen sulfide (H₂S), carbon dioxide (CO₂), etc., the environment may be corrosive to certain materials. As an example, an environment may be classified based at least in part on particulate matter that may be in a fluid (e.g., suspended, entrained, etc.). As an example, particulate matter in an environment may be abrasive or otherwise damaging to equipment. As an example, matter may be soluble or insoluble in an environment and, for example, soluble in one environment and substantially insoluble in another. As an example, hydrogen sulfide, carbon dioxide, water and/or particulate matter may be considered contaminants. Damaging action of one or more contaminants may be exacerbated by high temperature, high pressure, vibration, electrical and/or magnetic fields, etc.

Conditions in a geologic environment may be transient and/or persistent. Where equipment is placed within a geologic environment, longevity of the equipment can depend on characteristics of the environment and, for example, duration of use of the equipment as well as function of the equipment. For example, a high-voltage power cable may itself pose challenges regardless of the environment into which it is placed. Where equipment is to endure in an environment over an extended period of time, uncertainty may arise in one or more factors that could impact integrity or expected lifetime of the equipment. As an example, where a period of time may be of the order of decades, equipment that is intended to last for such a period of time should be constructed with materials that can endure environmental conditions imposed thereon, whether imposed by an environment or environments and/or one or more functions of the equipment itself.

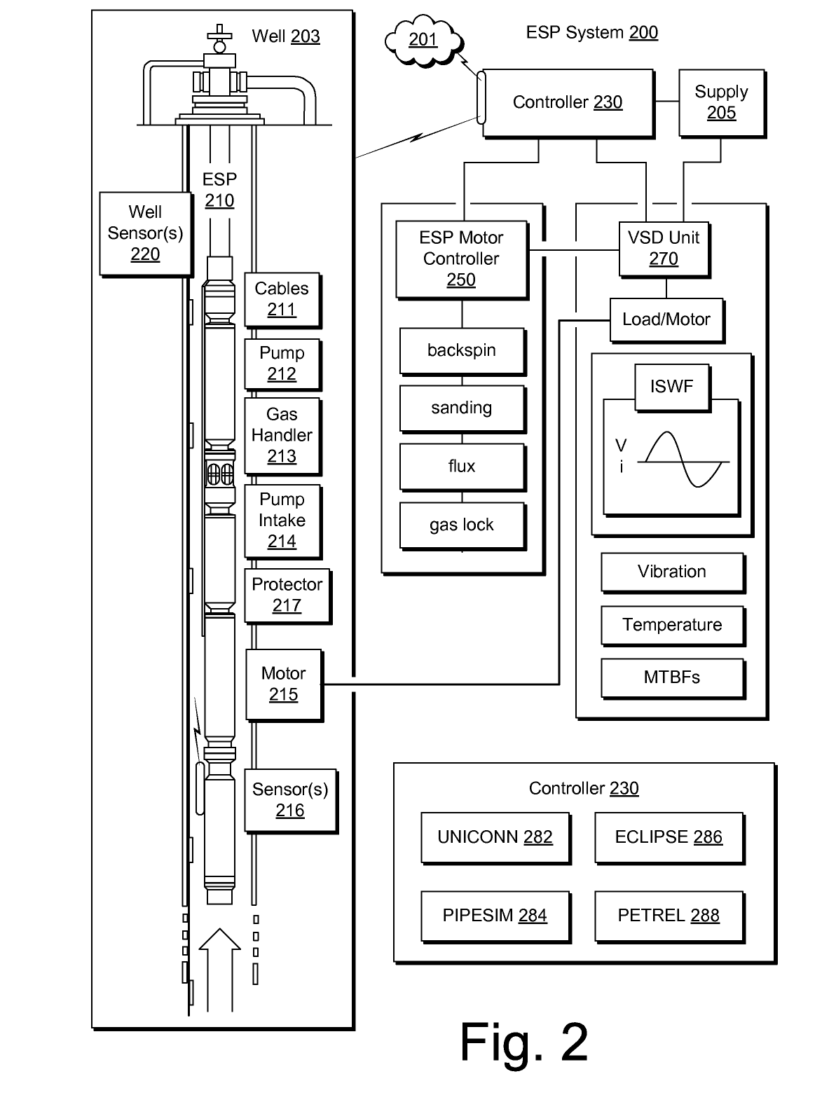

FIG. 2 shows an example of an ESP system 200 that includes an ESP 210 as an example of equipment that may be placed in a geologic environment. As an example, an ESP may be expected to function in an environment over an extended period of time (e.g., optionally of the order of years). As an example, consider a REDA™ ESP marketed by Schlumberger Limited, Houston, Tex., which may be disposed in a well and operated to lift fluid.

In the example of FIG. 2, the ESP system 200 includes a network 201, a well 203 disposed in a geologic environment, a power supply 205, the ESP 210, a controller 230, a motor controller 250 and a VSD unit 270. The power supply 205 may receive power from a power grid, an onsite generator (e.g., natural gas driven turbine), or other source. The power supply 205 may supply a voltage, for example, of about 4.16 kV.

As shown, the well 203 includes a wellhead that can include a choke (e.g., a choke valve). For example, the well 203 can include a choke valve to control various operations such as to reduce pressure of a fluid from high pressure in a closed wellbore to atmospheric pressure. Adjustable choke valves can include valves constructed to resist wear due to high-velocity, solids-laden fluid flowing by restricting or sealing elements. A wellhead may include one or more sensors such as a temperature sensor, a pressure sensor, a solids sensor, etc.

As to the ESP 210, it is shown as including cables 211 (e.g., or a cable), a pump 212, gas handling features 213, a pump intake 214, a motor 215, one or more sensors 216 (e.g., temperature, pressure, current leakage, vibration, etc.) and optionally a protector 217. The well 203 may include one or more well sensors 220 such as, for example, a fiber-optic based sensor, which may provide for real time sensing of temperature (e.g., in SAGD or other operations). As shown in the example of FIG. 1, a well can include a relatively horizontal portion. Such a portion may collect heated heavy oil responsive to steam injection. Measurements of temperature along the length of the well can provide for feedback, for example, to understand conditions downhole of an ESP.

In the example of FIG. 2, the controller 230 can include one or more interfaces, for example, for receipt, transmission or receipt and transmission of information with the motor controller 250, a VSD unit 270, the power supply 205 (e.g., a gas fueled turbine generator, a power company, etc.), the network 201, equipment in the well 203, equipment in another well, etc.

As shown in FIG. 2, the controller 230 can include or provide access to one or more modules or frameworks. Further, the controller 230 may include features of an ESP motor controller and optionally supplant the ESP motor controller 250. For example, the controller 230 may include the UNICONN™ motor controller 282 marketed by Schlumberger Limited (Houston, Tex.). In the example of FIG. 2, the controller 230 may access one or more of the PIPESIM™ framework 284, the ECLIPSE™ framework 286 marketed by Schlumberger Limited (Houston, Tex.) and the PETREL™ framework 288 marketed by Schlumberger Limited (Houston, Tex.) (e.g., and optionally the OCEAN™ framework marketed by Schlumberger Limited (Houston, Tex.)).

In the example of FIG. 2, the motor controller 250 may be a commercially available motor controller such as the UNICONN™ motor controller. The UNICONN™ motor controller can connect to a SCADA system, the ESPWATCHER™ surveillance system, etc. The UNICONN™ motor controller can perform some control and data acquisition tasks for ESPs, surface pumps or other monitored wells. The UNICONN™ motor controller can interface with the PHOENIX™ monitoring system (Schlumberger Limited, Houston Tex.), for example, to access pressure, temperature and vibration data and various protection parameters as well as to provide direct current power to downhole sensors. The UNICONN™ motor controller can interface with fixed speed drive (FSD) controllers or a VSD unit, for example, such as the VSD unit 270.

For FSD controllers, the UNICONN™ motor controller can monitor ESP system three-phase currents, three-phase surface voltage, supply voltage and frequency, ESP spinning frequency and leg ground, power factor and motor load.

For VSD units, the UNICONN™ motor controller can monitor VSD output current, ESP running current, VSD output voltage, supply voltage, VSD input and VSD output power, VSD output frequency, drive loading, motor load, three-phase ESP running current, three-phase VSD input or output voltage, ESP spinning frequency, and leg-ground.

The UNICONN™ motor controller can include control functionality for VSD units such as target speed, minimum and maximum speed and base speed (voltage divided by frequency); three jump frequencies and bandwidths; volts per hertz pattern and start-up boost; ability to start an ESP while the motor is spinning; acceleration and deceleration rates, including start to minimum speed and minimum to target speed to maintain constant pressure/load (e.g., from about 0.01 Hz/10,000 s to about 1 Hz/s); stop mode with PWM carrier frequency; base speed voltage selection; rocking start frequency, cycle and pattern control; stall protection with automatic speed reduction; changing motor rotation direction without stopping; speed force; speed follower mode; frequency control to maintain constant speed, pressure or load; current unbalance; voltage unbalance; overvoltage and undervoltage; ESP backspin; and leg-ground.

In the example of FIG. 2, the ESP motor controller 250 includes various modules to handle, for example, backspin of an ESP, sanding of an ESP, flux of an ESP and gas lock of an ESP. As mentioned, the motor controller 250 may include any of a variety of features, additionally, alternatively, etc.

In the example of FIG. 2, the VSD unit 270 may be a low voltage drive (VSD) unit, a medium voltage drive (MVD) unit or other type of unit (e.g., a high voltage drive, which may provide a voltage in excess of about 4.16 kV). For a LVD, a VSD unit can include a step-up transformer, control circuitry and a step-up transformer while, for a MVD, a VSD unit can include an integrated transformer and control circuitry. As an example, the VSD unit 270 may receive power with a voltage of about 4.16 kV and control a motor as a load with a voltage from about 0 V to about 4.16 kV.

The VSD unit 270 may include commercially available control circuitry such as the SPEEDSTAR™ MVD control circuitry marketed by Schlumberger Limited (Houston, Tex.). The SPEEDSTAR™ MVD control circuitry is suitable for indoor or outdoor use and comes standard with a visible fused disconnect switch, precharge circuitry, and sine wave output filter (e.g., integral sine wave filter, ISWF) tailored for control and protection of high-horsepower ESPs. The SPEEDSTAR™ MVD control circuitry can include a plug-and-play sine wave output filter, a multilevel PWM inverter output, a 0.95 power factor, programmable load reduction (e.g., soft-stall function), speed control circuitry to maintain constant load or pressure, rocking start (e.g., for stuck pumps resulting from scale, sand, etc.), a utility power receptacle, an acquisition system for the PHOENIX™ monitoring system, a site communication box to support surveillance and control service, a speed control potentiometer. The SPEEDSTAR™ MVD control circuitry can optionally interface with the SPEEDSTAR™ motor controller, which may provide some of the foregoing functionality.

In the example of FIG. 2, the VSD unit 270 is shown along with a plot of a sine wave (e.g., achieved via a sine wave filter that includes a capacitor and a reactor), responsiveness to vibration, responsiveness to temperature and as being managed to reduce mean time between failures (MTBFs). The VSD unit 270 may be rated with an ESP to provide for about 40,000 hours (5 years) of operational time. The VSD unit 270 may include surge and lightening protection (e.g., one protection circuit per phase). As to leg-ground monitoring or water intrusion monitoring, such types of monitoring can indicate whether corrosion is or has occurred. Further monitoring of power quality from a supply, to a motor, at a motor, may occur by one or more circuits or features of a controller.

While the example of FIG. 2 shows an ESP with centrifugal pump stages, another type of ESP may be included in the example of FIG. 2 and controlled via one or more controllers. For example, an ESP may include a hydraulic diaphragm electric submersible pump (HDESP), which is a positive-displacement, double-acting diaphragm pump with a downhole motor. HDESPs find use in low-liquid-rate coalbed methane and other oil and gas shallow wells that require artificial lift to remove water from the wellbore. HDESPs may handle a wide variety of fluids and, for example, up to about 2% sand, coal, fines and H₂S and/or CO₂.

As an example, an ESP may include motor such as a REDA™ ESP motor. Such a motor may be suitable for implementation in a thermal recovery heavy oil production system, such as, for example, SAGD system or other steam-flooding system.

As an example, an ESP motor can include a three-phase squirrel cage with two-pole induction. As an example, an ESP motor may include steel stator laminations that can help focus magnetic forces on rotors, for example, to help reduce energy loss. As an example, stator windings can include copper and insulation. As an example, a motor may be a multiphase motor that includes three or more phases and, for example, windings for each of the multiple phases.

For connection to a power cable or motor lead extensions (MLEs), a motor may include a pothead. Such a pothead may, for example, provide for a tape-in connection with metal-to-metal seals (e.g., to provide a barrier against fluid entry). A motor may include one or more types of potheads or connection mechanisms. As an example, a pothead unit may be provided as a separate unit configured for connection, directly or indirectly, to a motor housing.

As an example, a motor may include dielectric oil (e.g., or dielectric oils), for example, that may help lubricate one or more bearings that support a shaft rotatable by the motor. A motor may be configured to include an oil reservoir, for example, in a base portion of a motor housing, which may allow oil to expand and contract with wide thermal cycles. As an example, a motor may include an oil filter to filter debris. As an example, an oil may be or include a perfluoropolyether (PFPE) oil.

As an example, a motor housing can house stacked laminations with electrical windings extending through slots in the stacked laminations. The electrical windings may be formed from wire that may be referred to as “magnet wire” that includes an electrical conductor and at least one polymeric dielectric insulator surrounding the electrical conductor. As an example, a polymeric insulation layer may include a single layer or multiple layers of dielectric tape that may be helically wrapped around an electrical conductor and that may be bonded to the electrical conductor (e.g., and to itself) through use of an adhesive. As an example, insulation may include polytetrafluoroethylene (PTFE), optionally at least in part as expanded PTFE (ePTFE).

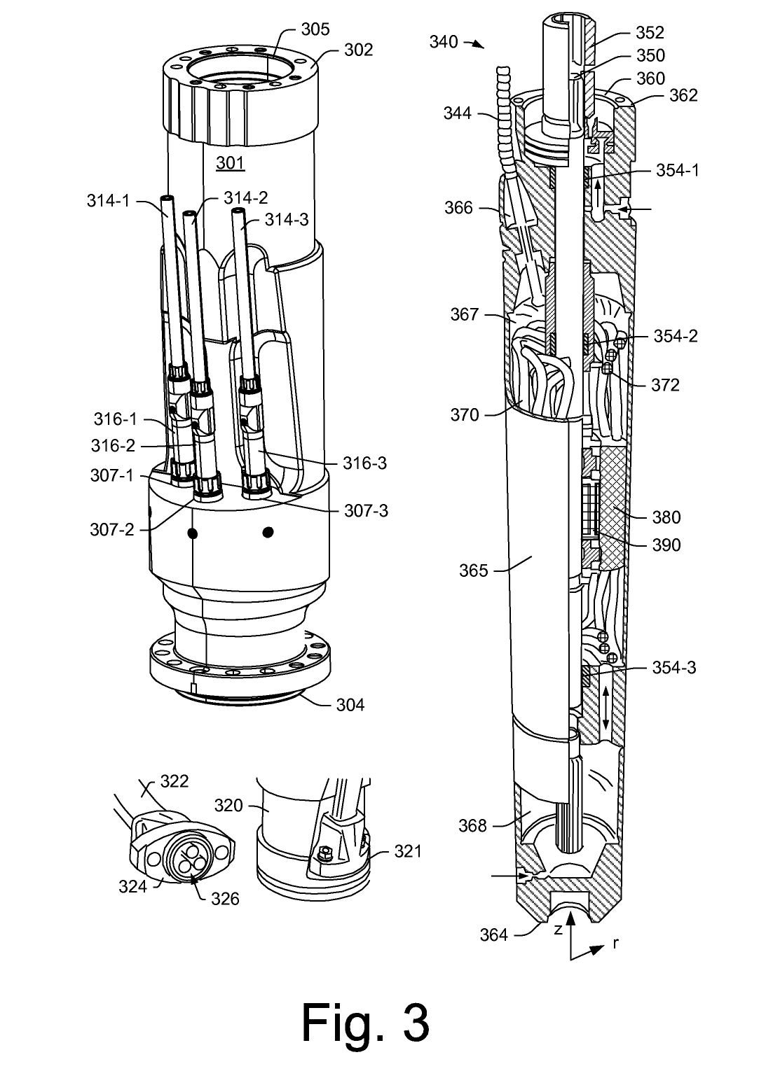

FIG. 3 shows various examples of motor equipment. A pothead unit 301 includes opposing ends 302 and 304 and a through bore, for example, defined by a bore wall 305. As shown, the ends 302 and 304 may include flanges configured for connection to other units (e.g., a protector unit at the end 302 and a motor unit at the end 304). The pothead unit 301 includes cable passages 307-1, 307-2 and 307-3 (e.g., cable connector sockets) configured for receipt of cable connectors 316-1, 316-2 and 316-3 of respective cables 314-1, 314-2 and 314-3. As an example, the cables 314-1, 314-2 and 314-3 and/or the cable connectors 316-1, 316-2 and 316-3 may include one or more polymers. For example, a cable may include polymer insulation while a cable connector may include polymer insulation, a polymer component (e.g., a bushing), etc. As an example, the cables 314-1, 314-2 and 314-3 may be coupled to a single larger cable. The single larger cable may extend to a connector end for connection to a power source or, for example, equipment intermediate the cable and a power source (e.g., an electrical filter unit, etc.). As an example, a power source may be a VSD unit that provides three-phase power for operation of a motor.

FIG. 3 also shows a pothead unit 320 that includes a socket 321. As an example, a cable 322 may include a plug 324 that can couple to the socket 321 of the pothead unit 320. In such an example, the cable 322 may include one or more conductors 326. As an example, a cable may include at least one fiber optic cable or one or more other types of cables.

Additionally, FIG. 3 shows a perspective cut-away view of an example of a motor assembly 340 that includes a power cable 344 (e.g., MLEs, etc.) to supply energy, a shaft 350, a housing 360 that may be made of multiple components (e.g., multiple units joined to form the housing 360), stacked laminations 380, windings 370 of wire (e.g., magnet wire) and a rotor 390 coupled to the shaft 350 (e.g., rotatably driven by energizing the windings 370).

As shown in FIG. 3, the shaft 350 may be fitted with a coupling 352 to couple the shaft to another shaft. A coupling may include, for example, splines that engage splines of one or more shafts. The shaft 350 may be supported by bearings 354-1, 354-2, 354-3, etc. disposed in the housing 360.

As shown in FIG. 3, the housing 360 includes opposing axial ends 362 and 364 with a substantially cylindrical outer surface 365 extending therebetween. The outer surface 365 can include one or more sealable openings for passage of oil (e.g., dielectric oil), for example, to lubricate the bearings and to protect various components of the motor assembly 340. As an example, the motor assembly 340 may include one or more sealable cavities. For example, a passage 366 allows for passage of one or more conductors of the cable 344 (e.g., or cables) to a motor cavity 367 of the motor assembly 340 where the motor cavity 367 may be a sealable cavity. As shown, the motor cavity 367 houses the windings 370 and the laminations 380. As an example, an individual winding may include a plurality of conductors (e.g., magnet wires). For example, a cross-section 372 of an individual winding may reveal a plurality of conductors that are disposed in a matrix (e.g., of material or materials) or otherwise bound together (e.g., by a material or materials). In the example of FIG. 3, the motor housing 360 includes an oil reservoir 368, for example, that may include one or more passages (e.g., a sealable external passage and a passage to the motor cavity 367) for passage of oil.

As explained above, equipment may be placed in a geologic environment where such equipment may be subject to conditions associated with a function or functions of the equipment and/or be subject to conditions associated with the geologic environment. Equipment may experience conditions that are persistent (e.g., relatively constant), transient or a combination of both.

As an example, equipment can include polytetrafluoroethylene (PTFE), optionally as expanded polytetrafluoroethylene (ePTFE). For example, a component may include a layer or layers that include ePTFE. As an example, equipment can include PTFE and ePTFE. As an example, equipment can include PTFE and a fluorinated lubricant (e.g., a fluorinated oil) such as, for example, a perfluoropolyether (PFPE) lubricant. As an example, equipment that includes PTFE may include at least a portion of the PTFE as ePTFE.

Polytetrafluoroethylene (PTFE) exhibits chemical resistance, thermal stability and hydrophobicity as well as oleophobicity to hydrocarbon oils. PTFE has a long, straight carbon backbone to which fluorine atoms are bonded. Both the carbon-carbon (C—C) bonds and carbon-fluorine (C—F) bonds are strong. In addition, the electron cloud of fluorine atoms forms a helical sheath that protects the carbon backbone. The distribution of fluorine atoms makes PTFE relatively nonpolar and nonreactive. The combination of strong bonds, a protective sheath, and nonpolarity lend to PTFE being inert and thermally stable. PTFE tends to be compatible with processing and cleaning fluids, including acids, bases, and solvents. Nonreactivity and nonpolarity of PTFE make it difficult for other materials to bond to it.

As fluorine (F) is the most electronegative element in the periodic table, it does not readily share electrons with neighboring fluorine atoms, which, for PTFE, results in a low surface free energy. The lower the surface free energy of a material, the less likely it is to be wetted with higher surface energy fluids such as water (e.g., about 73 dynes per cm at about 20 degrees C.). Table 1 presents some example PTFE properties.

TABLE 1
Example PTFE Properties

| Property | | |
|---|---|---|
| Structure | —(CF₂CF₂)-n | |
| Surface free energy | 18.5 | dynes per cm |
| Melt temperature | 327 | degrees C. |
| Continuous service | 288 | degrees C. |
| temperature | | |

Polymeric materials that have hydrogen or other elements rather than fluorine as in PTFE, tend to have weaker bonds and tend to be a more polar and reactive. Substitution of fluorine can also increase surface free energy; making such polymers less hydrophobic, less thermally stable, and more reactive than PTFE.

As an example, an ePTFE membrane may be made using PTFE fine powder resin where a lubricating agent is added so that the powder forms a paste that can be extruded into sheet form. The sheet may then be heated and expanded under the proper conditions to make a microporous sheet. The structure may be stabilized via an amorphous locking process. Though most polymers fracture when subjected to a high rate of strain, expanding PTFE at extremely high rates acts to increase the tensile strength of the polymer. As the added lubricating agent tends to be volatile, it may be removed from the porous structure during processing. As an example, a method may produce ePTFE that is approximately 100 percent PTFE (e.g., in an expanded form).

As an example, another method used to manufacture porous PTFE is a replication process in which PTFE particles are mixed with burnable material such as paper fibers, then heated to remove the paper fibers. As an example, PTFE can be made porous by removing a fugitive material such as a carbonate. Such methods may yield products that have lower flow rates and more contamination than the aforementioned extrusion and expansion method.

As an example, microporous ePTFE may include a microstructure characterized by nodes that are interconnected by fibrils. For example, ePTFE may be a single, continuous structure in which fibrils and nodes connect (e.g., without loose ends or particles to be shed). Even though there is a high density of thin fibrils, such a structure tends to be high flowing because it can also have a high void volume (e.g., consider a material that is about 85 percent porous). Table 2 shows example ePTFE properties including pore sizes, flow rates, and water breakthrough pressures.

TABLE 2
Example ePTFE Properties

| Property | Range | |
|---|---|---|
| Porosity | 1 to 99% | |
| Airflow | 2.0 to 15,000 | mL/cm² |
| Methanol flow rate | 1.0 to 10,000 | mL/cm² |
| Water entry pressure | 0 to 350 | psi |
| Isopropanol bubble point | 0.1 to >50 | psi |

| | |
|---|---|
| Pore size | 0.02 to 40μ |

Expanded PTFE membranes may be laminated to one or more materials for additional structural reinforcement. For example, an ePTFE membrane may be laminated to a felt material, a woven material and/or a nonwoven material. As an example, ePTFE may be provided in fiber form, sheet form, etc. As an example, ePTFE may be provided in monofilament form, in a form made of monofilaments, etc. As an example, GORE™ ePTFE fibers, as marketed by W. L. Gore & Associates, Inc., Newark, Del., are available with tenacities in excess of about 6 g/d (e.g., greater than about 170 ksi). As an example, an ePTFE fiber may be characterized by a linear mass density, for example, in units of denier (e.g., consider a fiber with a denier of about 200 d or more). A denier is a unit of mass in grams per 9000 meter (e.g., a 9000 meter long strand of silk has a mass of about one gram).

As an example, an ePTFE fiber with relatively low porosity may have a density of about 2.1 g per cubic centimeter. As an example, a lower density ePTFE (e.g., higher porosity) may provide available substructure for adding one or more active agents, fillers, etc., into the available pore volume, which at about 0.2 g per cubic centimeter may be as much as about 90 percent. Various fillers may be available for additional functionality (e.g., electrical conductivity, thermal conductivity, catalytic activity, active agents, etc.). As an example, organic filler and/or inorganic filler may be incorporated into an ePTFE structure. As an example, a filler may increase abrasion resistance, a filler may improve handling characteristics and/or a filler may alter wettability.

As an example, a fabric may include ePTFE fiber. In such an example, the ePTFE fiber may improve flexural durability and/or reduce tensile strength degradation of the fabric. As an example, inclusion of ePTFE in a material may act to increase flex endurance. As an example, a material may include ePTFE and para-aramid. As an example, a material may include ePTFE and E-glass (e.g., fiberglass). As an example, a fabric may include para-aramid fiber and ePTFE fiber. As an example, a fabric may include glass fiber and ePTFE fiber. As an example, a fabric may include woven fiber and PTFE. As an example, a fabric may include PTFE coated fabric.

As an example, a composite material can include PTFE. For example, consider various composite materials listed in Table 3.

TABLE 3
Example PTFE coated and fiberglass

| | Example | | | | |
|---|---|---|---|---|---|
| | CF103 | CF105 | CF106 | CF110 | CF114 |
| Weight | 4.4 | 8 | 9.4 | 15.9 | 21.25 |
| (oz./yd²) | | | | | |
| Thickness | 0.0032 | 0.0052 | 0.0060 | 0.0100 | 0.0138 |
| Breaking | 60 (warp) | 140 (warp) | 150 (warp) | 225 (warp) | 400 (warp) |
| Strength | 50 (fill) | 140 (fill) | 150 (fill) | 175 (fill) | 300 (fill) |
| (lbs./in.) | | | | | |
| Trapezoidal | 2 (warp) | 4 (warp) | 4 (warp) | 10 (warp) | 12 (warp) |
| Tear (lbs.) | 1 (fill) | 4 (fill) | 4 (fill) | 8 (fill) | 11 (fill) |
| Dielectric | 900 | 1100 | 1200 | 900 | 500 |
| Strength | | | | | |
| (V/mil) | | | | | |
| Resin (%) | 68 | 61 | 67 | 62 | 61 |
| Temperature | −240 to | −240 to | −240 to | −240 to | −240 to |
| Resistance | +500 | +500 | +500 | +500 | +500 |
| (degrees F.) | | | | | |
| Width (in.) | 40, 50, 60 | 40, 50, 60 | 40, 50, 60 | 40, 50, 60 | 40 |

As an example, an insulation system for an ESP motor can include PTFE, optionally at least in part as ePTFE. Such an insulation system may provide for resistance to harsh environments.

As an example, a material as an insulator for electrical conductors may provide desirable dielectric strength at low thicknesses (e.g., about 0.004 inch to about 0.008 inch; e.g., about 0.1 mm to about 0.2 mm). As an example, a material may exhibit thermal stability at an operational temperature of an ESP motor as installed in a downhole environment. For example, a SAGD ESP system may see motor temperatures as high as about 300 degrees C. and a high amperage subsea ESP system may see long term operation at temperatures in excess of about 180 degree C.

As an example, an insulation may include PTFE, optionally at least in part as ePTFE, with desirable mechanical properties. For example, such insulation may resist being damaged during a winding process for making a motor winding and/or may resist being abraded due to abrasive wear during operation of a motor (e.g., due to motor vibration, etc.). As an example, motor wire may be wound to a winding where the wire and/or a liner for a slot may exhibit a coefficient(s) of friction that allow for sliding in a motor slots (e.g., slots in laminated stacks, etc.). For example, wire may be wound and wrapped with a material that includes PTFE, optionally ePTFE, and/or wire may be provided with a layer of material that includes PTFE, optionally ePTFE. In such examples, a winding may be received by a slot, which may be unlined and/or lined. For example, a stack of plates may include slots where a slot may be lined with a slot liner that may include PTFE, optionally ePTFE. In such an example, a slot liner may be a fiberglass and PTFE material (e.g., formed as a fabric).

As an example, a material that includes PTFE, optionally at least in part in as ePTFE, may be compatible with a dielectric oil such as, for example, one or more types of ESP dielectric motor oils (e.g., mineral oils, polyalphaolefin (PAO) synthetic oils, etc.). As an example, a dielectric oil may be a perfluoropolyether (PFPE) oil, which, given its carbon-fluorine bonds, may be compatible with a material that includes PTFE and/or ePTFE.

As an example, a material that includes PTFE, optionally at least in part in as ePTFE, may be resistant to well fluids. For example, a material may resist degradation upon exposure to well fluid (e.g., such that a motor can continue to function in case of well fluid entry into the motor).

As an example, polyether ether ketone (PEEK) insulation of a conductor in a motor may perform in a downhole ESP at operating temperatures up to about 260 degrees C. Above about 260 degrees C., PEEK insulations may continue to function but tend to degrade with time. PEEK may also exhibit a loss of dielectric properties when exposed to high ambient humidity, making storage and manufacturing of PEEK insulated stators difficult.

While polyimide insulations can provide thermal stability, polyimide is subject to hydrolytic attack. As to thermal stability, with appropriate adhesive, polyimide wrapped magnet wire can be functional up to about 300 degrees C. However, at such temperature, presence of small amounts of moisture can cause degradation of polyimide via hydrolysis. Thus, polyimide, as an insulation material, may be limited by presence of moisture. In other words, for polyimide, moisture and temperature can be factors that affect performance.

As an example, a process may include producing ePTFE. For example, by stressing PTFE during processing, it is possible to create an expanded node-fibril molecular structure (ePTFE). As an example, ePTFE may be created with a tensile strength of about 20 times greater than that of standard PTFE where such ePTFE may also exhibit a greater dielectric strength than that of standard PTFE. As an example, ePTFE may include mechanical properties that equal or exceed those of various PEEK and polyimide materials while being resistant to hydrolysis.

As mentioned, equipment may be implemented in a high temperature environment where water and/or steam are present (e.g., consider SAGD). Where, for example, high temperature steam is present, it may act over time to degrade one or more equipment seals and thereby cause leakage into an equipment housing such as a motor housing. Where a motor housing houses one or more components that may include or be covered with polyimide, the polyimide may rapidly degrade via hydrolysis, which, for example, in turn, may cause a reduction in electrical insulation of one or more conductors that may be subject to short circuiting. As an example, a method can include constructing equipment with PTFE and/or ePTFE, which are resistant to hydrolysis. In such an example, the method may include positioning and operating the equipment in an environment where high temperature steam is present. In such an example, if water/steam leakage occurs (e.g., due to seal failure, etc.), risk of short circuiting of conductors may be reduced as PTFE and/or ePTFE are resistant to hydrolysis. Where the equipment includes an electric motor, it may be operable even though leakage exists. Thus, a field operation may continue with or without scheduling replacement/repair of the equipment (e.g., to maintain production levels, etc.).

As an example, ePTFE may be a commercially available High Strength Toughened (HSTF) ePTFE material as marketed by W. L. Gore & Associates, Inc., Newark, Del. (e.g., as a wire insulation material).

As an example, a dielectric magnet wire can include ePTFE as an insulating layer. As an example, a multicomponent cable can include ePTFE where the ePTFE may resist fluid. For example, ePTFE may be included in a multicomponent cable to reduce moisture loading, for example, at time of manufacture of the multicomponent cable and thereafter. In such an example, the multicomponent cable may include another material that may be subject to hydrolytic attack. As an example, a multicomponent cable may be effectively sealed where a seal layer include ePTFE, for example, to seal against fluid intrusion and to optionally insulate (e.g., as an electrical insulation).

As an example, a coated conductor can include a layer of ePTFE where the ePTFE is applied as a coating (e.g., about 0.001 inch to about 0.010 inch; e.g., about 0.025 mm to about 0.25 mm), optionally over a layer of polyimide. In such an example, the coated conductor may be more resistant to high temperature excursions as polyimide does not soften or melt (e.g., consider KAPTON™ polyimide as marketed by E. I. du Pont de Nemours and Company, Wilmington, Del.); noting that ePTFE may tend to soften and melt at temperatures above about 320 degrees C.

As an example, a power cable can include ePTFE, for example, as an insulator. As an example, a motor lead extension can include ePTFE, for example, as an insulator. In such examples, ePTFE may provide high dielectric strength and fluid resistance.

As an example, a power cable can include ePTFE, for example, applied as a barrier layer over primary insulation in the power cable. In such an example, high hoop strength and fluid resistance may act to reduce risk of damage during installation and/or operation of the power cable.

As an example, a gauge, which may be a sensor, can include ePTFE. For example, consider one or more conductors of the gauge including ePTFE as an insulator.

As an example, a wireline cable can include ePTFE. In such an example, the ePTFE may impart strength to the wireline cable by functioning as a structural member. In such an example, ePTFE may also act as a dielectric and/or a fluid barrier.

As an example, one or more sheets may include or be formed at least in part of ePTFE. For example, consider forming ePTFE into a sheet sized for use as a phase barrier tape and/or a slot liner film.

As an example, magnet wire of an electric motor of an electric submersible pump (ESP) may be insulated with ePTFE. An ESP that includes such magnet wire may be suited for applications with high operating temperatures in water or steam environments where long runtimes are desired (e.g., consider SAGD, geothermal and subsea wells). As an example, a slot liner of an electric motor of an electric submersible pump (ESP) may include ePTFE. As an example, a phase barrier film of an electric motor of an electric submersible pump (ESP) may include ePTFE.

As an example, an ESP can include ePTFE insulated wires. In such an example, the ePTFE insulated wires can provide an initial reduction in moisture and extend life of the ESP in the instance of fluid entry due to one or more leaking seals. Such an ESP may include or may not include one or more polyimide materials, which can degrade if exposed to moisture (e.g., in a manner where degradation may be accelerated with respect to temperature).

As to degradation of polyimide, a study by Campbell (Temperature Dependence, of Hydrolysis of Polyimide Wire Insulation, NRL Memorandum Report 5158, 1983), found that degradation of KAPTON™ polyimide film in aqueous media is due to a hydrolytic chain scission mechanism occurring at amide linkages and that water will attack the polyimide chain and produce degradation. The study also found that increasing the temperature of exposure accelerated degradation, which could be modeled by an Arrhenius rate equation that could be used to estimate lifetime of a polyimide insulated conductor for a given service temperature in the presence of deionized water, with possible extension of such a technique to humidity.

As an example, equipment can include a PTFE composite material. As an example, equipment can include ePTFE wire (e.g., wire with ePTFE as an insulation material). As an example, equipment can include an ePTFE slot liner film and/or a PTFE composite material slot liner film and ePTFE wire. In a hermetically sealed electric motor housing of an electric motor suitable for an electric submersible pump (ESP), by weight, a slot liner can be a primary contributor of moisture with respect to a stator of the electric motor. As an example, where a stator is formed of a material that includes PTFE and/or ePTFE, the stator may be dryer (e.g., with respect to moisture), which may improve ESP lifetime. Referring to Table 3, as an example, consider a stator that includes a composite PFTE/glass fabric film (e.g., CF103 or CF105) as a slot liner material.

As an example, a stator may be varnish-less and/or non-encapsulated with respect to varnish and/or encapsulation techniques that act to slow and/or prevent moisture attack of magnet wire. A varnish process may raise processability issues as to manufacture. In a motor housing that can contain dielectric oil, varnish may raise issues in high temperature applications (e.g., about 180 degrees C. or more) as degrading varnish can contaminate the dielectric oil. In high pressure applications, varnish may raise issues where trapped gas spaces (e.g., air, etc.) may be subjected to sudden collapse at high pressure (e.g., a reported source of failure in some varnished motors). As an example, a varnish-less stator may be serviceable in a manner where a varnished stator is not. For example, without varnish, a stator may be easier to strip and rewind (e.g., to rebuild the stator). As an example, a rotor may be varnish-less and optionally rebuildable.

As an example, to enhance equipment integrity (e.g., reduction in failures, increased performance, longevity, etc.), equipment may include PTFE and/or ePTFE. For example, the motor assembly 340 may include one or more materials that include or that are such a polymer composition. Such material may be for purposes of binding, for purposes of insulating, for purposes of reducing moisture content, for purposes of increasing temperature rating, etc. Such material may be for multiple purposes, for example, to bind and insulate as well as to reduce moisture content. As an example, consider inclusion of such material in a cavity, which may be a sealable cavity that may include one or more materials susceptible to hydrolysis. The inclusion of the material may reduce moisture load, for example, where it is chemically and/or structurally resistant to entraining or otherwise carrying moisture.

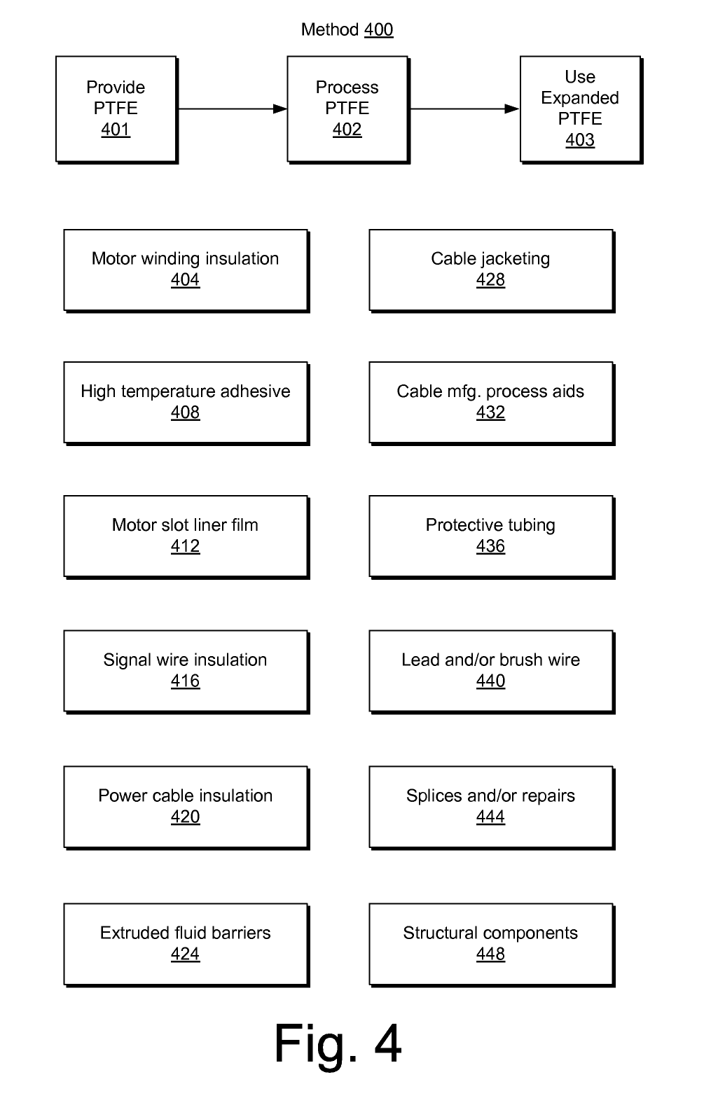

FIG. 4 shows of a method 400 that includes a provision block 401 for providing a PTFE, a process block 402 for processing the PTFE to produce expanded PTFE (ePTFE) and a use block 403 for using the produced ePTFE.

As to PTFE, it may be characterized to be non-melt flowable, for example, where it has a high molecular weight. However, as an example, PTFE may be provided with a low molecular weight (LMW) and, as such, be characterized to be melt flowable.

As an example, the method 400 may include making an ePTFE membrane from PTFE fine powder resin where a lubricating agent is added so that the powder forms a paste that can be extruded into sheet form. The sheet may then be heated and expanded under the proper conditions to make a microporous sheet. The structure may be stabilized via an amorphous locking process. Though various polymers may fracture when subjected to a high rate of strain, expanding PTFE at high rates acts to increase the tensile strength of the polymer. As the added lubricating agent tends to be volatile, it may be removed from the porous structure during processing. As an example, a method may produce ePTFE that is approximately 100 percent PTFE (e.g., at least in part in expanded structural form).

As an example, a method can include expanding a paste-formed product of a tetrafluoroethylene polymer to make it porous and stronger. Such a method can include subsequent heat treating to increase strength further, for example, while retaining a porous structure. As an example, a paste-forming technique may be employed to convert a polymer in paste form to a shaped article which is then expanded (e.g., after removing lubricant) by stretching it in one or more directions. In such an example, while held in a stretched condition, heating may occur to at least about 327 degrees C., followed by cooling. In such an example, porosity produced by expansion may be retained, for example, as there may be little or no coalescence or shrinking upon releasing the cooled, final article.

FIG. 4 also shows various components that can include ePTFE and/or uses for ePTFE. As shown, such components and/or uses may include those related to motor winding insulation 404, high temperature adhesive 408, motor slot liner film 412, signal wire insulation 416, power cable insulation 420, extruded fluid barriers 424, cable jacketing 428, cable manufacturing process aids 432, protective tubing 436, lead and/or brush wire 440, splices and/or repairs 444 and structural components (e.g., in electrical connectors, etc.).

As an example, one or more PTFE composite materials may be included in one or more of the aforementioned components and/or applied for one or more of the aforementioned uses.

As an example, PTFE and/or ePTFE may include PFPE oil and/or be present in an environment that includes PFPE oil (e.g., where PFPE oil may contact the PTFE and/or the ePTFE).

As to motor winding insulation 404, ePTFE has dielectric properties which make it suitable for electrical applications, for example, including motor magnet wire. As an example, the coefficient of friction of ePTFE may enhance motor winding. For example, where a winding is of considerable length (e.g., for a motor of about 10 feet or more), a low coefficient of friction may enhance a winding process (e.g., ensure smoother fitting and tightness of coated wire). As an example, ePTFE, begin hydrolysis resistant, may make windings less susceptible to moisture.

As an example, a winding made at least in part from ePTFE may introduce less moisture (e.g., water) into a motor cavity when compared to a more hygroscopic material or other material that may retain moisture. As an example, a motor may include materials susceptible to hydrolysis. In such an example, a motor assembly process may aim to reduce moisture to a minimum.

As an example, use of ePTFE may help to reduce moisture in a motor and thereby reduce hydrolysis or risk of hydrolysis of a material susceptible to hydrolysis in the motor. As an example, a calculation may be performed where material is assumed (e.g., or measured) as including a certain percentage of moisture. In turn, overall moisture content for materials introduced into a motor cavity may be determined. In an effort to reduce the overall moisture content, as an example, one or more components may be provided that include, at least in part, ePTFE.

As to high temperature adhesive 408, polyimide films that find use in magnet wire insulation may be held in place with material that includes ePTFE. As an example, ePTFE-based adhesive may be used as an adhesive for a polyimide tape. Coating the polyimide tape on one side or both sides with ePTFE-based material may provide a barrier to moisture that may improve resistance to hydrolysis of polyimide.

As an example, ePTFE may be provided as a coating for a material susceptible to hydrolysis. For example, a material that includes cyanate ester may be subject to hydrolysis. In such an example, the material may be coated with ePTFE to reduce migration of water to the material.

As an example, ePTFE may be provided to perform, for example, two functions: (i) a moisture barrier function; and (ii) a reduction in total moisture function. For example, where a material in a piece of equipment is susceptible to moisture, it may be coated with ePTFE to form a barrier to moisture and to reduce moisture in the equipment (e.g., when compared to another type of barrier that may carry more moisture into the equipment).

US Patent Application Publication No. 2009/0317264 A1, published Dec. 24, 2009, to Manke et al., entitled “ESP Motor Windings for High Temperature Environments” (assigned to Schlumberger Reservoirs Completions), which is incorporated by reference herein, describes an ESP system and various components thereof and one or more components that may include, for example, polyimide. As an example of a polyimide film, consider a KAPTON™ film (e.g., KAPTON™ FWR polyimide film). While the KAPTON™ FWR polyimide film may exhibit “improved” hydrolysis resistance, such improved resistance is described as being related to overlap (e.g., greater than 50% overlap). As an example, a film that includes polyimide may be coated (e.g., on one or both sides) with ePTFE or material that includes ePTFE, for example, to protect polyimide in the film from hydrolysis. As an example, such film may be in the form of tape, for example, where overlap may exist upon application of such film to a component. In such an example, overlap may be selected based on one or more criteria and may optionally be less than about 50%.

US Patent Application Publication No. 2010/0156215 A1, published Jun. 24, 2010, to Goertzen et al., entitled “High-Temperature Thermosetting Polymeric Materials for ESP Motor Applications” (assigned to Schlumberger Reservoirs Completions), which is incorporated by reference herein, describes an ESP system and various components thereof and one or more components that may include, for example, cyanate ester, bismaleimide, polyimide, benzoxazine, a preceramic polymer, or a mixture thereof. As an example, a component may include (e.g., be formed at least in part by) cyanate ester. Cyanate ester may be susceptible to hydrolysis, for example, at elevated temperatures. As an example, ePTFE or a material that includes ePTFE may be used in conjunction with material that includes cyanate ester. As an example, ePTFE or a material that includes ePTFE may lower moisture content, be used as a coating, etc. to help protect cyanate ester from hydrolysis.

As an example, a piece of equipment may include one or more cavities that may be sealed (e.g., hermetically sealed). Such sealing may form one or more seals (e.g., hermetic seals) that act to reduce risk of moisture entering the cavities and causing hydrolysis of a material or materials therein. As an example, ePTFE and/or PTFE may be provided in a cavity prior to sealing of the cavity. In such an example, the ePTFE and/or the PTFE may function as one or more of (i) a structural component, (ii) an insulator, (iii) a moisture barrier, and (iv) a component with a low moisture content.

As to a motor slot liner film 412, such a film may include ePTFE and/or PTFE. As an example, a motor slot liner film may be used to separate motor phases (e.g., wires, sections, etc. associated with individual phases of a multiphase motor). As an example, motor slot liner film with reduced moisture retention and/or moisture content may be used in a motor cavity to be sealed. For example, a ePTFE and/or a PTFE motor slot liner film may be introduced into a motor cavity prior to sealing of the cavity to reduce overall moisture content in the motor cavity (e.g., compared to a film that would introduce more moisture).

As to signal wire insulation 416, as an example, such insulation may be or include ePTFE and/or PTFE.

As to power cable insulation 420, ePTFE may exhibit a high dielectric strength, low loss and fluid resistance that make it suitable for use in or as power cable insulation. As an example, ePTFE may serve as a secondary insulation layer over lower profile materials such as polyimide tapes. As an example, ePTFE and/or PTFE may be compounded with one or more types of conductive fillers, for example, to form a semiconductive stress control layer for high voltage cable applications (e.g., voltage of about 4 to about 5 kV or more). As an example, for a power cable that includes an ePTFE-based insulator (and/or a PTFE-based insulator), the insulator may enhance voltage stress control layer and function as a fluid barrier (e.g., to water, hydrocarbons, etc.).

As an example, PTFE may be processed to include one or more fillers (e.g., electrically conductive and/or electrically non-conductive) and then processed to form ePTFE. As an example, PTFE may be processed to include one or more fillers (e.g., thermally conductive and/or insulating) and then processed to form ePTFE.

As to extruded fluid barriers 424, a PTFE and/or ePTFE may be extruded over (e.g., directly or indirectly) a material that is lead (Pb) or that includes lead (Pb). As an example, such an approach may be applied to form a protective layer for power cable, wireline cables or as a moisture protection layer for magnet wire.

As to cable jacketing 428, a cable may be jacketed with ePTFE and/or PTFE. As an example, a cable may be coated with an ePTFE tape and/or a PTFE tape. As an example, ePTFE and/or PTFE may be provided with one or more reinforcing fillers, for example, to increase mechanical strength, increase abrasion resistance, reduce gas permeability, increase tear resistance, etc.

As to protective tubing 436, ePTFE and/or PTFE may be used to form protective tubing, for example, for use in one or more applications such as, for example, internal motor components like magnet wire leads, splices, and brush wire leads.

As to lead and/or brush wire 440, such wire may include insulation that is ePTFE-based and/or PTFE-based. As an example, used of an ePTFE and/or a PTFE -based insulation in such wire may enhance function by enhancing flexibility and electrical properties, for example, when compared to a polyimide-based insulation (e.g., which may be subject to hydrolysis and stiffer).

As to splices and/or repairs 444, ePTFE and/or PTFE may be used for splices between cables or repairs of existing cables.

As to structural components (e.g., in electrical connectors) 448, as an example, ePTFE and/or PTFE may can be compounded with one or more fillers to create a high strength, high dielectric strength part that exhibits fluid and temperature resistance. As an example, such a part may be an electrical connector component.

As to power cables suitable for downhole operations, as an example, a round ESP cable rated for operation up to about 5 kV can include one or more copper conductors, oil and heat resistant EPDM rubber insulation (e.g., where The E refers to ethylene, P to propylene, D to diene and M refers to a classification in ASTM standard D-1418; e.g., ethylene copolymerized with propylene and a diene), a barrier layer (e.g., lead/fluoropolymer or none for low cost cables), a jacket (e.g., oil resistant EPDM or nitrile rubber), and armor (e.g., galvanized or stainless steel or MONEL™ alloy marketed by Inco Alloys International, Inc., Huntington, W. Va.). As another example, a flat ESP cable for operation up to about 5 kV can include one or more copper conductors, oil and heat resistant EPDM rubber insulation, a barrier layer (e.g., lead/fluoropolymer or none for low cost cables), a jacket layer (oil resistant EPDM or nitrile rubber or none for low cost cables), and armor (galvanized or stainless steel or MONEL™ alloy marketed by Inco Alloys International, Inc., Huntington, W. Va.).

As an example, the aforementioned round ESP cable and flat ESP cable may include ePTFE and/or PTFE. As an example, such materials may be substituted, at least in part, for the EPDM rubber insulation, be provided as a barrier layer for lead (Pb), etc.

As an example of a REDAMAX™ HOTLINE™ ESP power cable (as marketed by Schlumberger Limited, Houston, Tex.), a 5 kV round ELBE G5R can include solid conductor sizes of about #1 AWG (e.g., 1 AWG/1), about # 2 AWG (e.g., 2 AWG/1) and about #4 AWG (e.g., 4 AWG/1). As to conversion to metric, #1, #2 and #4 AWG correspond to approximately 42.4 mm², 33.6 mm², and 21.1 mm², respectively. As another example, a 5 kV flat EHLTB G5F can include a solid conductor size of #4 AWG (e.g., 4 AWG/1). As an example, dimensions may be, for round configurations, about 1 to 2 inches in diameter and, for flat configurations, about half an inch by about 1 inch to about 2 inches. As an example, weights may range from about 1 lbm per foot to about 3 lbm per foot. As an example, the aforementioned round ESP cable and flat ESP cable may include ePTFE and/or PTFE.

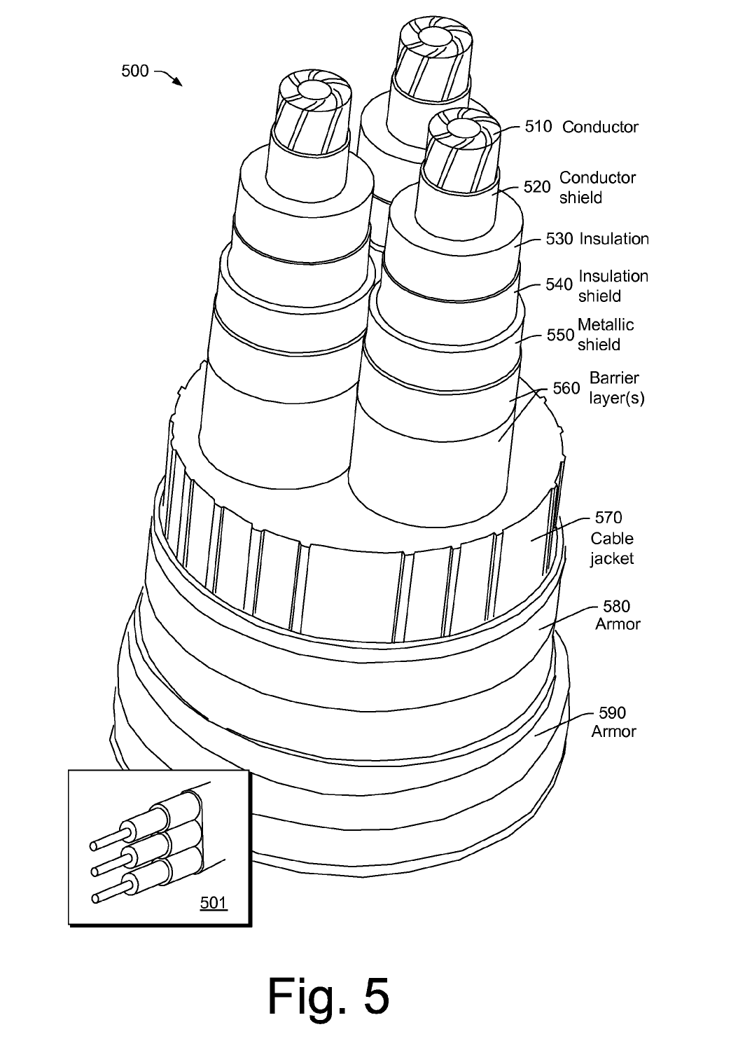

FIG. 5 shows an example of a power cable 500, suitable for use in the ESP system 200 of FIG. 2 or optionally one or more other systems (e.g., SAGD, etc.). In the example of FIG. 5, the power cable 500 includes three conductor assemblies where each assembly includes a conductor 510, a conductor shield 520, insulation 530, an insulation shield 540, a metallic shield 550, and one or more barrier layers 560. The three conductor assemblies are seated in a cable jacket 570, which is surrounded by a first layer of armor 580 and a second layer of armor 590.

As to the conductor 510, it may be solid or compacted stranded high purity copper and coated with a metal (e.g., tin, lead, nickel, silver or other metal or alloy). As to the conductor shield 520, it may be a semiconductive material with a resistivity less than about 5000 ohm-m and be adhered to the conductor 510 to reduce or eliminate voids therebetween. As an example, the conductor shield 520 may be provided as an extruded polymer (e.g., a polymer mixture) that penetrates into spaces between strands of the stranded conductor 510. As to extrusion of the conductor shield 520, it may optionally be co-extruded or tandem extruded with the insulation 530. As an option, nanoscale fillers may be included for low resistivity and suitable mechanical properties (e.g., for high temperature thermoplastics).

As to the Insulation 530, it may be bonded to the conductor shield 520. As an example, the insulation 530 may include ePTFE and/or PTFE.

As to the insulation shield 540, it may be a semiconductive material having a resistivity less than about 5000 ohm-m. The insulation shield 540 may be adhered to the insulation 530, but, for example, removable for splicing, without leaving any substantial amounts of residue. As an example, the insulation shield 540 may be extruded polymer, for example, co-extruded with the insulation 530.

As to the metallic shield 550, it may be or include lead (Pb), as lead tends to be resistant to downhole fluids and gases. One or more lead layers may be provided, for example, to create an impermeable gas barrier.

As to the barrier 560, it may include ePTFE and/or PTFE, for example, as tape that may be helically taped.

As to the cable jacket 570, it may be round or as shown in an alternative example, rectangular (e.g., “flat”). As to material of construction, a cable jacket may include one or more layers of EPDM, nitrile, HNBR, fluoropolymer, chloroprene, or other material (e.g., to provide for resistance to a downhole and/or other environment). As an example, each conductor assembly phase may include solid metallic tubing, such that splitting out the phases is more easily accomplished (e.g., to terminate at a connector, to provide improved cooling, etc.). As an example, the cable jacket 570 may be formed using ePTFE and/or PTFE.

As to the cable armor 580 and 590, metal or metal alloy may be employed, optionally in multiple layers for improved damage resistance.

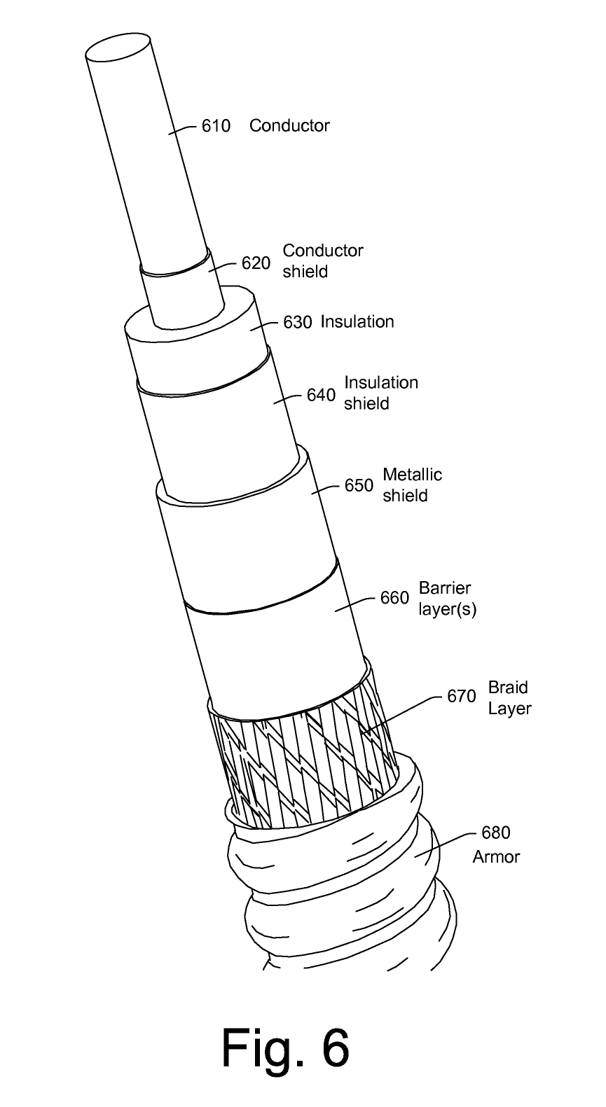

FIG. 6 shows an example of one of the MLEs 600 suitable for use in the system 200 of FIG. 2 or optionally one or more other systems (e.g., SAGD, etc.). In the example of FIG. 6, the MLE 600 (or “lead extension”) a conductor 610, a conductor shield 620, insulation 630, an insulation shield 640, a metallic shield 650, one or more barrier layers 660, a braid layer 670 and armor 680. While the example of FIG. 6 mentions MLE or “lead extension”, it may be implemented as a single conductor assembly cable for any of a variety of downhole uses.

A power cable for artificial lift equipment can include one or more conductor assemblies, each including a copper conductor (e.g., solid, stranded, compacted stranded, etc.), a conductor shield with resistivity less than about 5000 ohm-m surrounding the conductor, insulation, an insulation shield having a resistivity less than 5000 ohm-m surrounding the insulation, a metallic shield surrounding the insulation shield, and a polymer barrier surrounding the metallic shield. Such a cable may include a jacket molded about the one or more conductor assemblies and optionally armor surrounding the jacket. As an example, a cable that may be rated for use at over 5 kV may include one or more of a semiconductive conductor shield and a semiconductive insulation shield.

A power cable for downhole equipment can include a copper conductor (e.g., optionally solid); a conductor shield with resistivity less than about 5000 ohm-m surrounding the conductor; insulation (e.g., optionally a perfluoropolymer (PFP) mixture heat ageable to promote epitaxial co-crystallization (ECC) to thereby produce an ECC PFP); an insulation shield having a resistivity less than about 5000 ohm-m surrounding the insulation; a metallic shield surrounding the insulation shield; a polymer barrier surrounding the metallic shield; a braided layer surrounding the metallic shield; and armor surrounding the braided layer.

As to a braid of a braided layer, various types of materials may be used such as, for example, polyethylene terephthalate (PET) (e.g., applied as a protective braid, tape, fabric wrap, etc.). PET may be considered as a relatively low cost and relatively high strength material. As an example, a braid layer can help provide protection to a soft lead jacket during an armor wrapping process. In such an example, once downhole, the function of the braid may be minimal. As to other examples, nylon or glass fiber tapes and braids may be implemented. Yet other examples can include fabrics, rubberized tapes, adhesive tapes, and thin extruded films. As an example, the braid layer 670 may be formed using ePTFE and/or PTFE. As an example, ePTFE and/or PTFE may help to protect one or more other layers during an armoring process, for example, that applies the armor 680.

As an example, a conductor (e.g., solid or stranded) may be surrounded by a semiconductive material layer that acts as a conductor shield where, for example, the layer has a thickness greater than approximately 0.005 inch (e.g., about 0.13 mm). As an example, a cable can include a conductor with a conductor shield that has a radial thickness of approximately 0.010 inch (e.g., about 0.25 mm). As an example, a cable can include a conductor with a conductor shield that has a radial thickness in a range from greater than approximately 0.005 inch to approximately 0.015 inch (e.g., about 0.13 mm to about 0.38 mm).

As an example, a conductor may have a conductor size in a range from approximately #8 AWG (e.g., OD approx. 0.128 inch or area of approx. 8.36 mm²) to approximately #2/0 “00” AWG (e.g., OD approx. 0.365 inch or area of approx. 33.6 mm²). As examples, a conductor configuration may be solid or stranded (e.g., including compact stranded). As an example, a conductor may be smaller than #8 AWG or larger than #2/0 “00” AWG (e.g., #3/0 “000” AWG, OD approx. 0.41 inch or area of approx. 85 mm²).

As an example, one or more layers of a cable may be made of a material that is semiconductive (e.g., a semiconductor). Such a layer (e.g., or layers) may include a polymer or polymer blend with one or more conductive fillers (e.g., carbon black, graphene, carbon nanotubes, etc.) and optionally one or more additives (e.g., elastomer compound components, process aids, etc.). As an example, a layer may include ePTFE and/or PTFE and a graphite filler (e.g., expanded graphite, etc.).

As an example, a cable may include a conductor that has a size within a range of approximately 0.1285 inch (e.g., 3.3 mm) to approximately 0.414 inch (e.g., 10.5 mm) and a conductor shield layer that has a radial thickness within a range of approximately greater than 0.005 inch to approximately 0.015 inch (e.g., about 0.13 mm to about 0.38 mm).

As an example, a cable may include a conductor with a conductor shield (e.g., a semiconductor layer) and insulation (e.g., an insulation layer) where the conductor shield and the insulation are extruded. For example, the conductor shield may be extruded onto the conductor followed by extrusion of the insulation onto the conductor shield. Such a process may be performed, for example, using a co-extrusion, a sequential extrusion, etc. As an example, a shield and/or insulation may be formed using ePTFE and/or PTFE.

As an example, insulation may include one layer or multiple layers of a high temperature polymeric dielectric material. As an example, polymeric insulating material may be in the form of tape that may be applied helically or longitudinally (e.g., by wrapping polyimide tape onto a conductor in an overlap configuration).

As an example, multiple layers may be applied to a conductor (e.g., directly or indirectly). As an example, a thickness of a polymer insulator layer may be from about 0.0005 inch to about 0.005 inch (e.g., about 0.013 mm to about 0.13 mm). As an example, a polymer insulator layer may be a polyimide film, for example, optionally coated on one side or both sides (e.g., directly and/or indirectly) with a material (e.g., ePTFE and/or PTFE).

As an example, a polymer insulator may be commercially available (e.g., consider various polymers marketed by E. I. du Pont de Nemours and Company, Wilmington, Delaware). As to a polyimide, consider the E. I. du Pont de Nemours and Company polymer 150PRN411, which may be used as polymer insulation; where “150” indicates a 1.5 mils overall tape thickness, where “PRN” indicates an HN polyimide film with a high temperature fluoropolymer adhesive, where “4” indicates a 0.0004 inch thick high temperature adhesive on the bottom side of the tape, where the first “1” indicates the thickness of the polyimide film and where the second “1” indicates a 0.0001 inch thick high temperature adhesive on the top side of the tape.

As an example, polyimide may be deposited via an extrusion process. As an example, polyimide may be co-extruded with another material such as, for example, a perfluoropolymer (PFP)-based material.

As an example, a cable may include a conductor shield, insulation and an insulation shield that have been extruded separately (e.g., by separate extruders with a delay to allow for hardening, etc.). As an example, a cable may include a conductor shield, insulation and insulation shield formed via co-extrusion, for example, using separate extrusion bores that feed to an appropriate cross-head, extrusion die or dies that deposit the layers in a substantially simultaneous manner (e.g., within about a minute or less).

As an example, an extrusion process may be controlled to allow for some amount of intermixing at an interface between two layers, for example, to provide for more complete bonding between the two layers. For example, as a conductor shield/insulation interface may be subject to high levels of electrical stress, an extrusion process may be performed to minimize defects, voids, contamination, etc., via intermixing at the interface (e.g., via co-extrusion of the two layers). As to an insulation shield, as mentioned, ease of removal may be beneficial when making connections. Further, electrical stresses tend to diminish for layers positioned outside of an insulation layer.

In comparison to tape, extrusion may provide for a reduction in the overall dimension of a cable (e.g., in some oil field applications, well clearance may be a concern). Extruded layers tend to be smoother than tape, which can help balance out an electrical field. For example, a tape layer or layers over a conductor can have laps and rough surfaces that can cause voltage stress points. Taping for adjacent layers via multiple steps may risk possible contamination between the layers. In contrast, a co-extrusion process may be configured to reduce such contamination. For example, co-extrusion may help to eliminate voids, contamination, or rough spots at a conductor shield/insulation interface, which could create stress points where discharge and cable degradation could occur. Thus, for improved reliability, smoothness and cleanness, a conductor shield may be extruded, optionally co-extruded with insulation thereon.

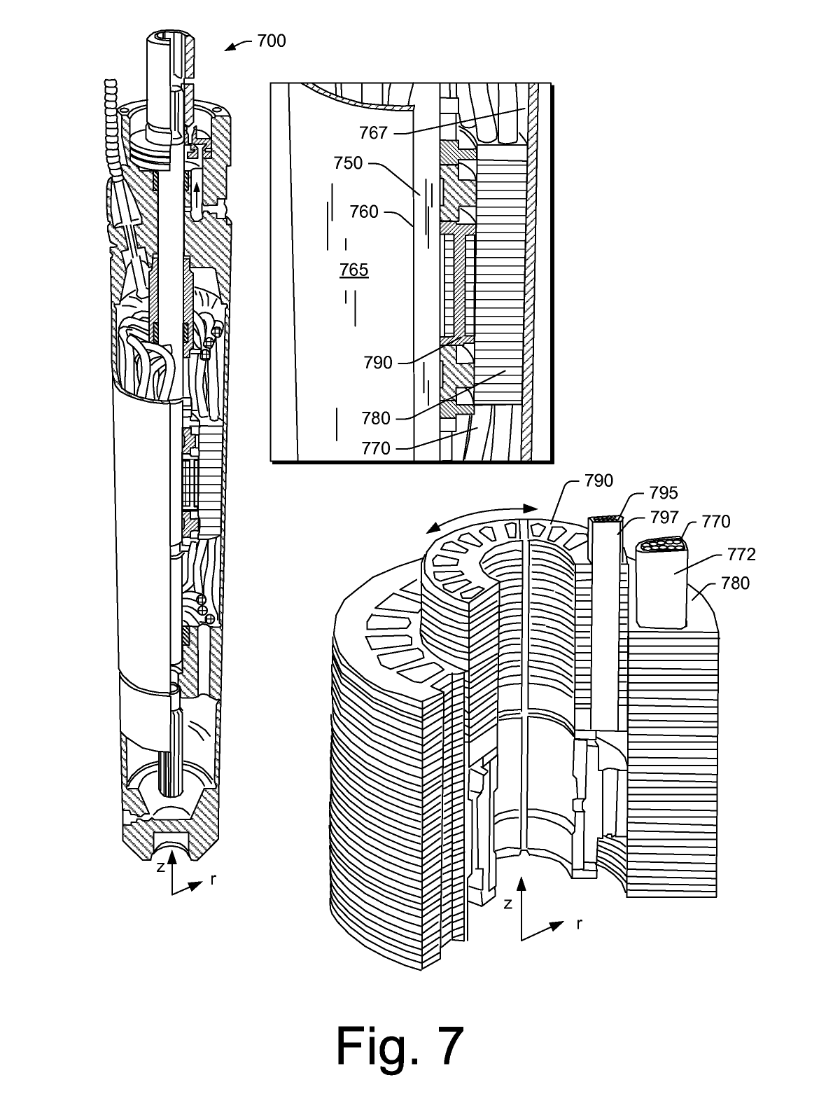

FIG. 7 shows an example of an electric motor assembly 700 that includes a shaft 750, a housing 760 with an outer surface 765 and an inner surface 767, stator windings 770, stator laminations 780, rotor laminations 790 and rotor windings 795. As shown, the rotor laminations 790 are operatively coupled to the shaft 750 such that rotation of the rotor laminations 790, with the rotor windings 795 therein, can rotate the shaft 750.

In the example of FIG. 7, material 772 may include ePTFE and/or PTFE. Such material may be provided as slot liner material, for example, to line slots of the stator laminations 780.

In the example of FIG. 7, material 797 may include ePTFE and/or PTFE. Such material may be provided as slot liner material, for example, to line slots of the rotor laminations 790.

As an example, the stator windings 770 may include wire coated with ePTFE and/or PTFE. As an example, the rotor windings 795 may include wire coated with ePTFE and/or PTFE.

As an example, the stator windings 770 may be unvarnished. As an example, the rotor windings 795 may be unvarnished. As an example, the stator windings 770 may be replaceable by sliding them out of slots in the stator laminations 780. As an example, the rotor windings 795 may be replaceable by sliding them out of slots in the rotor laminations 790.

As an example, the housing 765 may define a cavity via its inner surface 767 where the cavity may be hermetically sealed. As an example, such a cavity may be filled at least partially with dielectric oil.

As an example, the assembly 700 may include ePTFE and/or PTFE and not include polymeric materials subject to hydrolytic degradation. As an example, the assembly 700 may include ePTFE and/or PTFE and include one or more polymeric materials subject to hydrolytic degradation. In such an example, the ePTFE and/or PTFE may reduce loading of moisture in the assembly 700.

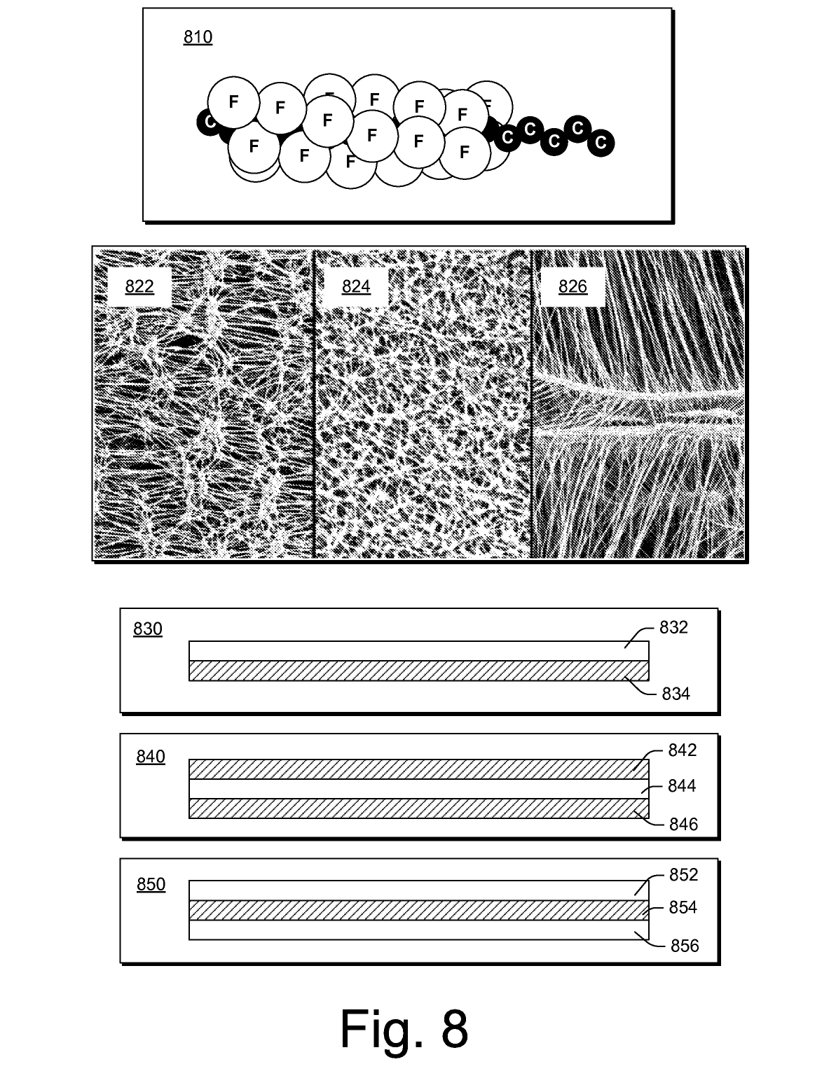

FIG. 8 shows a diagram 810 of PTFE via representations of carbon and fluorine atoms, examples of micrographs 822, 824 and 826 of ePTFE structures and examples of layered materials 830, 840 and 850 where at least one layer includes PTFE and/or ePTFE. As an example, the materials 830, 840 and 850 may be laminated materials. For example, a layer of PTFE or a layer of ePTFE may be laminated to another material (e.g., woven, nonwoven, etc.). As shown in FIG. 8, the material 830 includes a layer 832 and a layer 834 where the layer 834 may be or include PTFE and/or ePTFE; the material 840 includes a layer 842, a layer 844 and a layer 846 where the layers 842 and 846 may be or include PTFE and/or ePTFE; and the material 850 includes a layer 852, a layer 854 and a layer 856 where the layer 854 may be or include PTFE and/or ePTFE.

As an example, a composite film material may include PTFE and/or ePTFE. As an example, a composite film material may include polyimide. For example, consider one or more layers of a laminated material including a polyimide or polyimides. For example, the layers material 840 of FIG. 8 may include one sheet of polyimide disposed between two sheets of PTFE, two sheets of ePTFE, a sheet of PTFE and a sheet of ePTFE. As an example, such sheets may be layers that are laminated together, for example, via chemical and/or mechanical bonding.

As to the diagram 810, PTFE is shown as a linear chain polymer with a relatively smooth molecular profile, which may include about 20,000 to about 200,000 repeating units of tetrafluoroethylene (C₂F₄). The fluorine encasement of the carbon backbone provides high chemical inertness, while its smooth profile provides low friction sliding. PTFE exhibits hydrophobicity and oleophobicity, as to hydrocarbon oils.

Membranes made of ePTFE can be made with various degrees of porosity as well as shapes of pore (see, e.g., the micrographs 822, 824 and 826). For example, an ePTFE membrane may include a porosity (or porosities) in a range from about 1 percent to about 99 percent. As mentioned, PTFE and ePTFE are hydrophobic. As an example, a sufficiently porous ePTFE membrane, if exposed to water, may retain some amount of water and may, for example, allow water vapor to pass (e.g., via convection, diffusion, etc.). As an example, one or more layers of the layered materials 830, 840 and 850 may include a material with a structure such as a structure of one of the micrographs 822, 824 and 826.

Water, which is a polar, V-shaped molecule has a diameter of about 2.75 Å. As an example, a cross-sectional diameter of a linear polymer chain that includes carbon and fluorine (e.g., fluorocarbon polymers, etc.) may be of the order of 4 Å or more. For example, a perfluoropolyether (PFPE) linear chain polymer may have a diameter of the order of about 6 Å to about 7 Å.

PFPE may be a liquid and classified using a letter K, Y, D, M or Z; whereas PTFE may be a solid, optionally with some amount of porosity, and ePTFE may be a solid with some amount of porosity. While each of the foregoing types (e.g., K, Y, D, M and Z) of PFPE includes carbon, oxygen and fluorine atoms, the types differ structurally as to how these atoms are combined (e.g., linear, branched, etc.). Differences in bonding can influence properties such as, for example, temperature, lubricity, viscosity index, volatility, film formation/re-formation, wettability, etc. As to density, PFPE may have a density of the order of about 1.9 g per cubic centimeter, which is about twice as dense as a polyalphaolefin oil (e.g., consider PAO oil such as PAO-6, which is a polymeric hydrocarbon-based synthetic oil). The density of a PFPE oil may be attributed to high atomic mass and molecular structure.

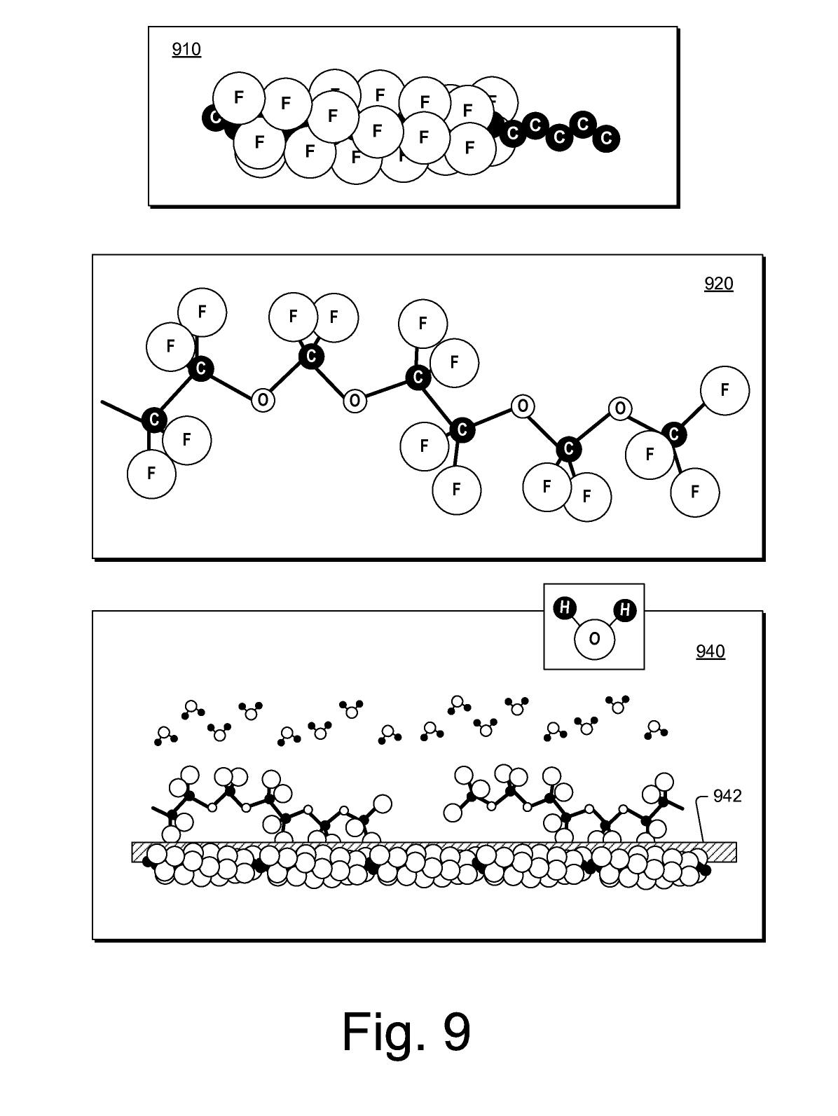

FIG. 9 shows a diagram 910 of PTFE, a diagram 920 of an example of a PFPE oil and a diagram 940 that includes an example of a material 942 that includes PTFE and/or ePTFE. As illustrated in the diagram 940, the material 942 may be hydrophobic while allowing for “wetting” by PFPE oil. Depending on the porosity of the material 942, which may be relatively non-porous to highly porous, the material 942 may pass PFPE oil more readily than water given the presence of fluorine atoms of the PFPE oil.

As an example, equipment may include PTFE and/or ePTFE and one or more types of PFPE oil. As to some examples of PFPE oil, consider KRYTOX™ GPL-106 and XHT-500 (e.g., a higher temperature grade) as marketed by E. I. du Pont de Nemours and Company, Wilmington, Del.; CASTROL™ BRAYCO™ 1727 as marketed by BP, London, UK; and UNIFLUOR™ 8120 as marketed by Nye Lubricants, Inc., Fairhaven, Mass.

As an example, a system such as an ESP system may include PFPE oil and ePTFE and/or PTFE. In such an example, the ePTFE and/or PTFE may be present to electrically insulate one component from another component (e.g., or components).

As an example, a system such as an ESP system can include a fluorinated solid and/or porous insulating material and a fluorinated oil. In such an example, the fluorinated material and fluorinated oil may allow for wetting (e.g., the oil can wet surfaces of the material). In such an example, surfaces wetted with PFPE oil may be protected against hydrocarbon and/or water in that displacement of PFPE oil by hydrocarbon and/or water may be thermodynamically unfavorable given the hydrophobic and oleophobic nature of fluorinated materials such as PTFE and/or ePTFE. Such an approach can enhance resistance of a system to contaminating fluids, whether introduced at time of assembly (e.g., consider moisture) and/or at a later time (e.g., during shipment, installation, operation, etc.).

As an example, ePTFE may include porosity where pore are at least in part infiltrated by PFPE oil. For example, a method can include utilizing porosity of an ePTFE film by at least partially impregnating the ePTFE film with PFPE oil. A method may include placing ePTFE components in a vessel that includes PFPE oil and pressurizing the vessel and/or heating the vessel. As an example, mechanical energy may be applied, as to moving PFPE oil, moving an ePTFE film, etc. As an example, similarities in surface energy between an ePTFE film and PFPE oil may allow for preferential permeation of PFPE oil into the ePTFE film where, for example, the PFPE oil may act to hinder (e.g., block) other hydrocarbons or polar fluids from migrating into the film.

As an example, PFPE oil can act to increase dielectric properties of one or more wires (e.g., conductors), for example, by displacing one or more contaminants by the PFPE oil where such one or more contaminants have unfavorable dielectric properties (e.g., with respect to insulation of one or more wires). As an example, a cavity that includes PTFE (e.g., optionally at least in part as ePTFE) and/or material that includes PTFE (e.g., optionally at least in part as ePTFE) may include PFPE oil that may be protective as a dielectric oil and that may have an affinity to PTFE such that a substance (e.g., a contaminant) with lesser affinity to PTFE (e.g., optionally repelled by PTFE) does not displace the PFPE oil. For example, where affinity exists between PTFE oil and PTFE-based insulation of a conductor (e.g., or conductors), the PTFE oil may be difficult to displace by one or more contaminants with lesser affinity (e.g., or no affinity to the PTFE-based insulation) and the dielectric properties of the PTFE oil may be superior to the one or more contaminants. In such an example, PTFE oil on a surface and/or within a PTFE-based insulation of a conductor (e.g., or conductors) may enhance performance of the conductor (e.g., or conductors), particularly where an environment includes one or more contaminants. For example, consider water as a contaminant to a polyimide insulation or other insulation susceptible to hydrolytic attack. In such an example, a PTFE-based insulation may be disposed about the susceptible insulation. Further, where PTFE oil is present and in contact with the PTFE-based insulation, penetration of water to the susceptible insulation may be hindered. In such an example, the combination of PTFE-based insulation and PTFE oil can protect against one or more of hydrolytic attack and decrease in dielectric properties favorable to insulation of a conductor or conductors.

As an example, for equipment to be located in or located in a downhole environment, an impregnation process may occur in that downhole environment. For example, a cavity of a piece of equipment may include ePTFE and PFPE oil where conditions in a downhole and/or operational conditions of the equipment (e.g., supplying power, heat generation, pressure, etc.) may promote impregnation of the ePTFE with the PFPE oil. As an example, an ESP motor can include ePTFE and PFPE oil in a cavity of the ESP motor where pressure and/or temperature associated with conditions in a downhole environment promote migration of the PFPE oil into pores of the ePTFE (e.g., ePTFE material).

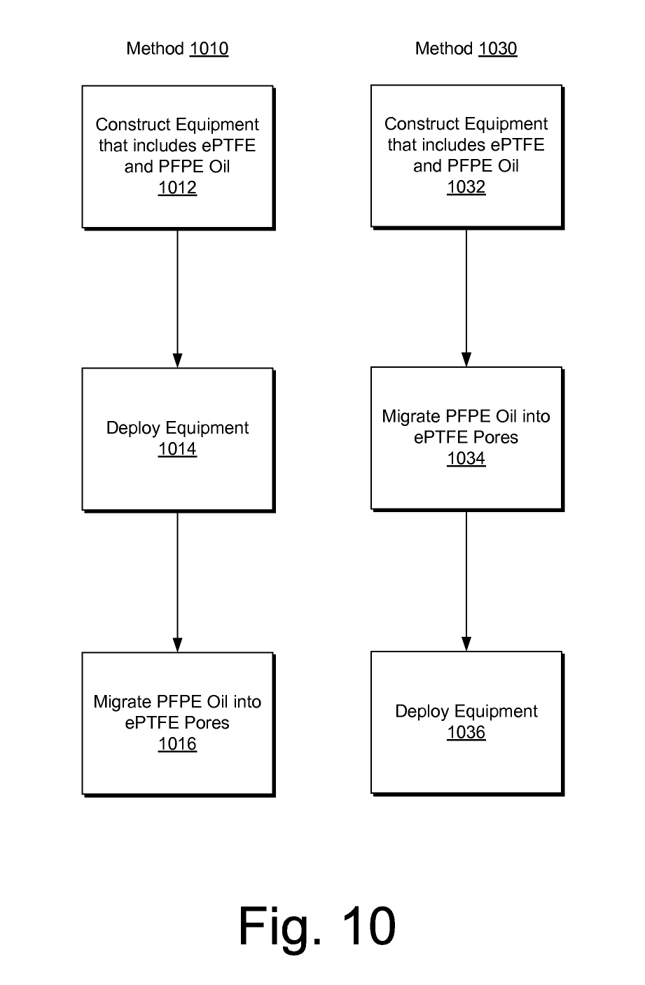

FIG. 10 shows an example of a method 1010 and an example of a method 1030. As shown, the method 1010 includes a construction block 1012 for constructing equipment that includes ePTFE and PFPE oil, a deployment block 1014 for deploying the equipment (e.g., in an environment) and a migration block 1016 for migrating at least a portion of the PFPE oil into pores of the ePTFE.

As shown, the method 1030 includes a construction block 1032 for constructing equipment that includes ePTFE and PFPE oil, a migration block 1034 for migrating at least a portion of the PFPE oil into pores of the ePTFE and a deployment block 1036 for deploying the equipment (e.g., in an environment). In such an example, the migration block 1034 can include subjecting the equipment to one or more conditions that promote migration of the PFPE oil into pores of the ePTFE.

As an example, a method can include constructing equipment that includes ePTFE and PFPE oil, subjecting the equipment to one or more conditions that promote migration of the PFPE oil into pores of the ePTFE, deploying the equipment in a downhole environment and operating the deployed equipment where conditions of the downhole environment and/or conditions of operating promote further migration of the PFPE oil into pores of the ePTFE. In such an example, where intrusion of fluid occurs into the equipment (e.g., via failure of a seal, etc.), the PFPE oil in the ePTFE may act to hinder passage of the fluid into the ePTFE (e.g., and through the ePTFE). As an example, equipment can include PFPE oil impregnated in pores of ePTFE where the PFPE oil in the pores acts to hinder wetting of the ePTFE by hydrocarbons and/or water.

As an example, wire for use in an ESP may be ePTFE insulated wire. In such an example, the wire may provide an initial reduction in moisture and provide resistance to damaging fluid(s) that may a cavity of the ESP, for example, due to a leaking seal.

As an example, depending on material of construction, handling, etc., a slot liner may contribute moisture to a stator of a motor. In such an example, the amount of moisture may be dependent on mass of the slot liner (e.g., more mass may result in more entrainment of moisture). As an example, a slot liner may be formed of a material that is hydrophobic to reduce moisture in a motor (e.g., a sealed cavity of a motor). For example, consider an ESP motor that includes a slot liner that includes a PTFE composite material and/or an ePTFE material. In such an example, the motor may also include wire insulated with ePTFE. Such a motor may be a low-moisture load motor due in part to the hydrophobic nature of PTFE and ePTFE.

As an example, a motor may include no varnish. For example, where one or more hydrophobic materials such as PTFE and/or ePTFE are used to construct the motor, a certain level of moisture may be tolerated as the hydrophobic materials may act as barriers to migration of that moisture to surfaces that could be damaged (e.g., degrade in the presence of moisture, etc.). For example, PTFE and/or ePTFE may protect motor wire from moisture. Where such motor wire includes a polyimide insulation, the PTFE and/or ePTFE may hinder migration of moisture to the polyimide and subsequent degradation of the polyimide by hydrolytic attack. A varnish-less motor may operate at sustained temperatures (e.g., about 180 degrees or more) without experiencing types of damage that may be associated with degradation of varnish of varnished wire/stator motors.

As an example, a varnish-less approach to a motor may act to avoid varnish associated issues such as trapped air spaces that can suddenly collapse under higher pressure. For example, varnish may be applied as a high viscosity liquid that can entrain air where the air may be trapped as bubbles upon hardening of the varnish. Such trapped air bubbles tend to be at the pressure of the environment in which the varnish was applied, for example, atmospheric pressure. Where the varnish is exposed to higher pressures, the trapped air bubbles may be weaknesses in the varnish as the trapped atmospheric pressure is insufficient to sustain the applied higher pressure. Bubble collapse can lead to cracking of varnish, which, in turn, can provide paths for fluid migration. As an example, a varnish-less motor may be readily amenable to rebuilding, servicing, etc. when compared to a varnished motor (e.g., with varnished wire, stators, etc.). For example, rebuilding may include stripping and rewinding of a motor, which, for a varnished motor, may first include varnish removal.

As an example, copper wire for motor windings can include at least one layer of a material that includes ePTFE. In such an example, the copper wire may be about 8 AWG (0.1285 inch diameter, 3.3 mm diameter). As an example, ePTFE may be applied as tape, for example, as an insulator. As an example, wire with at least one layer of ePTFE may have a lesser moisture load due in part to the hydrophobic nature of ePTFE. As an example, copper wire may be nickel plated, for example, to resist H₂S. As an example, at least one layer of ePTFE about a wire may act to resist abrasion, for example, as may be associated with vibration, a winding process, etc.

As an example, a wire may include multiple types of insulators. For example, a wire may include polyimide as an insulator and PTFE and/or ePTFE as an insulator where, for example, a core of the wire (e.g., a copper core) is larger than 31 AWG (0.00893 inch diameter, 0.23 mm diameter).

As an example, a motor can include an ePTFE slot liner or a slot liner that includes ePTFE. For example, a material may be wrapped in ePTFE tape (e.g., or ePTFE sheet). As an example, a glass matrix or a fiber matrix may be wrapped in ePTFE tape (e.g., or ePTFE sheet). As an example, a slot liner may be an ePTFE composite material. As an example, a slot liner may be a glass fabric with a layer of PTFE and/or ePTFE (e.g., as a wrapping, etc.).

As an example, a multiphase motor may include a phase barrier tape that includes ePTFE.

As an example, a motor may be a polyimide-free motor. As an example, a motor may be a varnish-less motor. As an example, a motor may be polyimide-free and varnish-less. In such an example, the motor may be an ESP motor.

As an example, a wireline cable may include ePTFE, for example, to impart strength such that the ePTFE functions as a structural member and a dielectric and/or a fluid barrier.

As an example, an electric submersible pump (ESP) motor can include a housing; a cavity defined at least in part by the housing; a rotor disposed in the cavity; a stator disposed in the cavity where the stator includes stator laminations and stator windings disposed at least in part in slots of the stator laminations; and stator slot liners disposed at least in part in the slots of the stator laminations where the stator slot liners include polytetrafluoroethylene (PTFE). In such an example, the PTFE can include expanded PTFE (ePTFE).

As an example, stator slot liners can include one or more of glass, tape and sheets. As an example, an ESP motor can include a cavity and perfluoropolyether (PFPE) oil in the cavity and in contact with PTFE and/or ePTFE.

As an example, an ESP motor can include a rotor that includes rotor laminations and rotor windings disposed at least in part in slots of the rotor laminations and, for example, rotor slot liners disposed at least in part in the slots of the rotor laminations where the rotor slot liners include PTFE, ePTFE or PTFE and ePTFE. As an example, an ESP motor can include multiple phases and phase barrier material that includes PTFE, ePTFE or PTFE and ePTFE.

As an example, an electric submersible pump (ESP) motor can include a housing; a cavity defined at least in part by the housing; a rotor disposed in the cavity where the rotor includes rotor laminations and rotor windings disposed at least in part in slots of the rotor laminations; and a stator disposed in the cavity where the stator includes stator laminations and stator windings disposed at least in part in slots of the stator laminations, where the rotor windings, the stator windings or the rotor windings and the stator windings include expanded polytetrafluoroethylene (ePTFE). In such an example, the cavity can include perfluoropolyether (PFPE) oil that is in contact with at least a portion of the ePTFE and, for example, occupying at least a portion of porosity of the ePTFE.

As an example, rotor windings, stator windings or rotor windings and stator windings can include copper wire, for example, consider AWG copper wire. In such an example, the ePTFE may electrically insulate the copper wire.

As an example, an ESP motor may include a varnish-less stator. As an example, stator windings of a stator may be slidably removable from slots of stator laminations. As an example, stator slot liners may be disposed at least in part in slots of such stator laminations where the stator slot liners include polytetrafluoroethylene (PTFE).

As an example, rotor windings, stator windings or rotor windings and stator windings may include polyimide. In such an example, ePTFE may coat the polyimide (e.g., as tape, sheets, a composite material, etc.). As an example, ePTFE may be a barrier material for polyimide where the ePTFE and the polyimide are electrical insulators.

As an example, motor can include a housing; a cavity defined at least in part by the housing; at least one component that includes polytetrafluoroethylene (PTFE) disposed in the cavity; and perfluoropolyether (PFPE) oil in the cavity and in contact with the PTFE. In such an example, the motor may be a pump motor. For example, the motor may be an ESP motor.

As an example, motor can include a housing; a cavity defined at least in part by the housing; at least one component that includes expanded polytetrafluoroethylene (ePTFE) disposed in the cavity; and perfluoropolyether (PFPE) oil in the cavity and in contact with the ePTFE. In such an example, the motor may be a pump motor. For example, the motor may be an ESP motor.

As an example, one or more methods described herein may include associated computer-readable storage media (CRM) blocks. Such blocks can include instructions suitable for execution by one or more processors (or cores) to instruct a computing device or system to perform one or more actions.

According to an embodiment, one or more computer-readable media may include computer-executable instructions to instruct a computing system to output information for controlling a process. For example, such instructions may provide for output to sensing process, an injection process, drilling process, an extraction process, an extrusion process, a pumping process, a heating process, etc.

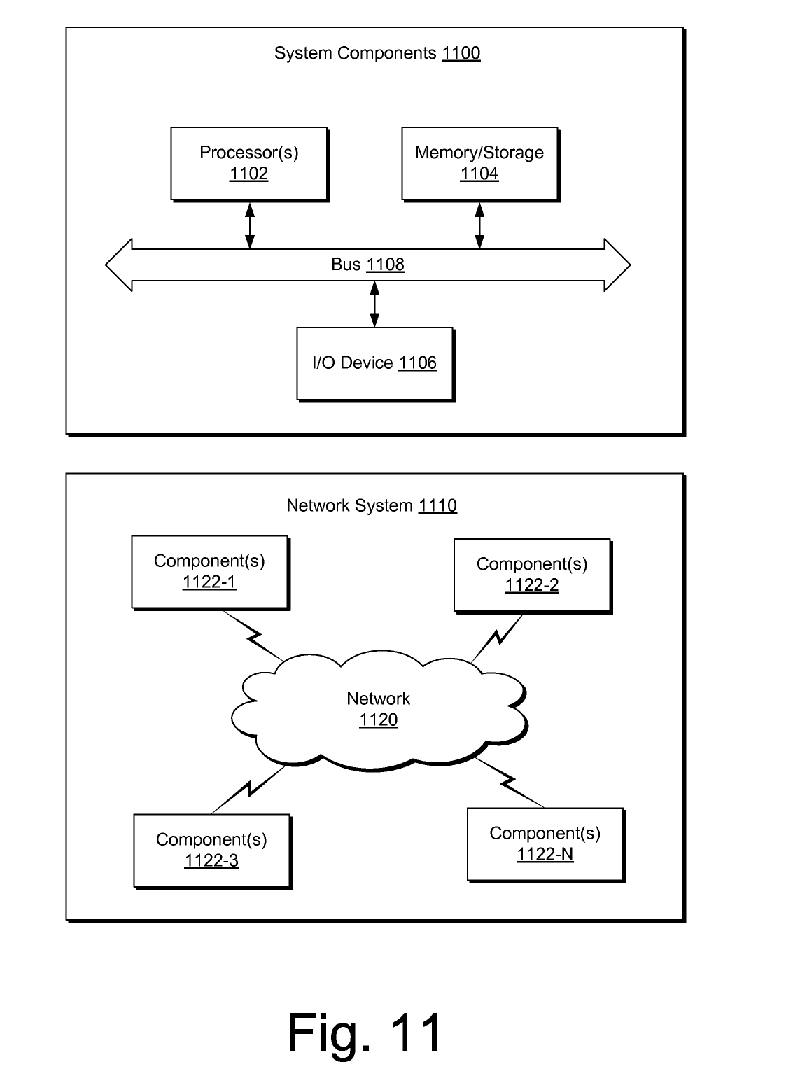

FIG. 11 shows components of a computing system 1100 and a networked system 1110. The system 1100 includes one or more processors 1102, memory and/or storage components 1104, one or more input and/or output devices 1106 and a bus 1108. According to an embodiment, instructions may be stored in one or more computer-readable media (e.g., memory/storage components 1104). Such instructions may be read by one or more processors (e.g., the processor(s) 1102) via a communication bus (e.g., the bus 1108), which may be wired or wireless. The one or more processors may execute such instructions to implement (wholly or in part) one or more attributes (e.g., as part of a method). A user may view output from and interact with a process via an I/O device (e.g., the device 1106). According to an embodiment, a computer-readable medium may be a storage component such as a physical memory storage device, for example, a chip, a chip on a package, a memory card, etc.

According to an embodiment, components may be distributed, such as in the network system 1110. The network system 1110 includes components 1122-1, 1122-2, 1122-3, . . . 1122-N. For example, the components 1122-1 may include the processor(s) 1102 while the component(s) 1122-3 may include memory accessible by the processor(s) 1102. Further, the component(s) 1102-2 may include an I/O device for display and optionally interaction with a method. The network may be or include the Internet, an intranet, a cellular network, a satellite network, etc.

### Conclusion

Although only a few examples have been described in detail above, those skilled in the art will readily appreciate that many modifications are possible in the examples. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words “means for” together with an associated function.

What is claimed is:

1. An electric submersible pump motor comprising:
a housing;
a cavity defined at least in part by the housing;
a rotor disposed in the cavity;
a stator disposed in the cavity wherein the stator comprises stator laminations and stator windings disposed at least in part in slots of the stator laminations; and
stator slot liners disposed at least in part in the slots of the stator laminations wherein the stator slot liners comprise polytetrafluoroethylene.

2. The electric submersible pump motor of claim 1 wherein the polytetrafluoroethylene comprises expanded polytetrafluoroethylene.

3. The electric submersible pump motor of claim 1 wherein the stator slot liners comprise glass.

4. The electric submersible pump motor of claim 1 wherein the stator slot liners comprise tape or sheets.

5. The electric submersible pump motor of claim 1 comprising perfluoropolyether oil in the cavity and in contact with the polytetrafluoroethylene.

6. The electric submersible pump motor of claim 2 wherein the stator slot liners comprise glass.

7. The electric submersible pump motor of claim 2 wherein the stator slot liners comprise tape or sheets.

8. The electric submersible pump motor of claim 2 comprising perfluoropolyether oil in the cavity and in contact with the expanded polytetrafluoroethylene.

9. The electric submersible pump motor of claim 1 wherein the rotor comprises rotor laminations and rotor windings disposed at least in part in slots of the rotor laminations and wherein the rotor comprises rotor slot liners disposed at least in part in the slots of the rotor laminations wherein the rotor slot liners comprise polytetrafluoroethylene, expanded polytetrafluoroethylene or polytetrafluoroethylene and expanded polytetrafluoroethylene.

10. The electric submersible pump motor of claim 1 comprising multiple phases and phase barrier material that comprises polytetrafluoroethylene, expanded polytetrafluoroethylene or polytetrafluoroethylene and expanded polytetrafluoroethylene.

11. An electric submersible pump motor comprising:
a housing;
a cavity defined at least in part by the housing;
a rotor disposed in the cavity wherein the rotor comprises rotor laminations and rotor windings disposed at least in part in slots of the rotor laminations; and
a stator disposed in the cavity wherein the stator comprises stator laminations and stator windings disposed at least in part in slots of the stator laminations,
wherein the rotor windings, the stator windings or the rotor windings and the stator windings comprise expanded polytetrafluoroethylene.

12. The electric submersible pump motor of claim 11 wherein the rotor windings, the stator windings or the rotor windings and the stator windings comprise copper wire.

13. The electric submersible pump motor of claim 12 wherein the copper wire comprises 8 AWG copper wire.

14. The electric submersible pump motor of claim 12 wherein the expanded polytetrafluoroethylene electrically insulates the copper wire.

15. The electric submersible pump motor of claim 11 comprising perfluoropolyether oil in the cavity and in contact with the expanded polytetrafluoroethylene.

16. The electric submersible pump motor of claim 11 wherein the stator comprises a varnish-less stator.

17. The electric submersible pump motor of claim 16 wherein the stator windings are slidably removable from the slots of the stator laminations.

18. The electric submersible pump motor of claim 11 wherein the rotor windings, the stator windings or the rotor windings and the stator windings comprise polyimide and wherein the expaned polytetrafluoroethylene coats the polyimide.

19. The electric submersible pump motor of claim 11 comprising stator slot liners disposed at least in part in the slots of the stator laminations wherein the stator slot liners comprise polytetrafluoroethylene.

20. An electric submersible pump motor comprising:
a housing;
a cavity defined at least in part by the housing;
at least one component that comprises polytetrafluoroethylene disposed in the cavity; and
perfluoropolyether oil in the cavity and in contact with the polytetrafluoroethylene.
